(19) United States
(12) Patent Application Publication
(10) Pub. No.: US 2020/0051001 A1
(43) Pub. Date: Feb. 13, 2020

(54) Systems and Methods for Autonomous Robot Delivery and Retrieval

(71) Applicant: UATC, LLC, San Francisco, CA (US)

(72) Inventor: Richard Brian Donnelly, Pittsburgh, PA (US)

(21) Appl. No.: 16/173,431

(22) Filed: Oct. 29, 2018

Related U.S. Application Data
(60) Provisional application No. 62/749,171, filed on Oct. 23, 2018.
(60) Provisional application No. 62/716,063, filed on Aug. 8, 2018.

(51) Int. Cl. G06Q 10/08; G06Q 10/02; G06Q 50/30; G01C 21/34; G05D 1/00

(52) U.S. Cl. CPC G06Q 10/083; G06Q 10/02; G06Q 50/30; G05D 2201/0216; G05D 1/0088; G05D 2201/0213; G01C 21/3438

(57) ABSTRACT

Systems and methods are directed to the transportation of autonomous robots. In one example, a computing system performs operations including obtaining data associated with a request for an autonomous robot transport service; determining an availability of one or more autonomous vehicles for the autonomous robot transport service; selecting an autonomous vehicle to provide transport of an autonomous robot associated with the autonomous robot transport service based at least in part on the availability of one or more autonomous vehicles and the data associated with the request for the autonomous robot transport service; generating an autonomous robot service assignment for the selected autonomous vehicle based at least in part on the data associated with the request for the autonomous robot transport service; and providing data indicative of the autonomous robot service assignment to the selected autonomous vehicle for the selected autonomous vehicle to perform the autonomous robot transport service.

### PRIORITY CLAIM

The present application is based on and claims the benefit of United States Provisional Application 62/716,063 having a filing date of Aug. 8, 2018 and United States Provisional Application 62/749,171 having a filing date of Oct. 23, 2018, which are hereby incorporated by reference herein in their entirety for all purposes.

### FIELD

The present disclosure relates generally to operation of an autonomous robot in conjunction with an autonomous vehicle. More particularly, the present disclosure relates to systems and methods that provide for the management of an autonomous robot that provides for the distribution of goods in association with an autonomous vehicle.

### BACKGROUND

An autonomous vehicle is a vehicle that is capable of sensing its environment and navigating with little to no human input. In particular, an autonomous vehicle can observe its surrounding environment using a variety of sensors and can attempt to comprehend the environment by performing various processing techniques on data collected by the sensors. This can allow an autonomous vehicle to navigate without human intervention and, in some cases, even omit the use of a human driver altogether.

### SUMMARY

Aspects and advantages of embodiments of the present disclosure will be set forth in part in the following description, or can be learned from the description, or can be learned through practice of the embodiments.

One example aspect of the present disclosure is directed to a computing system. The computing system includes one or more processors; and one or more memories including instructions that, when executed by the one or more processors, cause the one or more processors to perform operations. The operations include obtaining data associated with a request for an autonomous robot transport service. The operations further include determining an availability of one or more autonomous vehicles for the autonomous robot transport service based at least in part on the request for the autonomous robot transport service. The operations further include selecting an autonomous vehicle to provide transport of an autonomous robot associated with the autonomous robot transport service based at least in part on the availability of one or more autonomous vehicles and the data associated with the request for the autonomous robot transport service. The operations further include generating an autonomous robot service assignment for the selected autonomous vehicle based at least in part on the data associated with the request for the autonomous robot transport service. The operations further include providing data indicative of the autonomous robot service assignment to the selected autonomous vehicle for the selected autonomous vehicle to perform the autonomous robot transport service.

Another example aspect of the present disclosure is directed to a computer-implemented method for management of an autonomous robot. The method includes obtaining, by a computing system comprising one or more comping devices, data associated with a request for an autonomous robot transport service. The method further includes determining, by the computing system, an availability of one or more autonomous vehicles for the autonomous robot transport service based at least in part on the request for the autonomous robot transport service. The method further includes providing, by the computing system, one or more of service timing or service pricing to a user requesting the autonomous robot transport service based at least in part on the data associated with the request for the autonomous robot transport service and the availability of one or more autonomous vehicles. The method further includes selecting, by the computing system, an autonomous vehicle to provide transport of an autonomous robot associated with the autonomous robot transport service based at least in part on the availability of one or more autonomous vehicles and the data associated with the request for the autonomous robot transport service. The method further includes generating, by the computing system, an autonomous robot service assignment for the selected autonomous vehicle based at least in part on the data associated with the request for the autonomous robot transport service. The method further includes providing, by the computing system, data indicative of the autonomous robot service assignment to the selected autonomous vehicle.

Another example aspect of the present disclosure is directed to a system. The system includes an autonomous robot including one or more compartments configured to provide for transporting at least one item. The system further includes one or more autonomous vehicles, the one or more autonomous vehicles configured to transport the autonomous robot along with one or more passengers. The system further includes a computing system. The computing system includes one or more processors; and one or more memories including instructions that, when executed by the one or more processors, cause the one or more processors to perform operations. The operations include obtaining data associated with a request for an autonomous robot transport service associated with the autonomous robot. The operations further include determining an availability of the one or more autonomous vehicles for the transport service based at least in part on the request for the autonomous robot transport service. The operations further include selecting one of the one or more autonomous vehicles to provide transport of the autonomous robot based at least in part on the availability of the one or more autonomous vehicles and the data associated with the request for the autonomous robot transport service. The operations further include generating an autonomous robot service assignment for the selected autonomous vehicle based at least in part on the data associated with the request for the autonomous robot transport service. The operations further include providing data indicative of the autonomous robot service assignment to the selected autonomous vehicle.

Other aspects of the present disclosure are directed to various systems, apparatuses, non-transitory computer-readable media, user interfaces, and electronic devices.

The autonomous vehicle technology described herein can help improve the safety of passengers of an autonomous vehicle, improve the safety of the surroundings of the autonomous vehicle, improve the experience of the rider and/or operator of the autonomous vehicle, as well as provide other improvements as described herein. Moreover, the autonomous vehicle technology of the present disclosure can help improve the ability of an autonomous vehicle to effectively provide vehicle services to others and support the various members of the community in which the autonomous vehicle is operating, including persons with reduced mobility and/or persons that are underserved by other transportation options. Additionally, the autonomous vehicle of the present disclosure may reduce traffic congestion in communities as well as provide alternate forms of transportation that may provide environmental benefits.

These and other features, aspects, and advantages of various embodiments of the present disclosure will become better understood with reference to the following description and appended claims. The accompanying drawings, which are incorporated in and constitute a part of this specification, illustrate example embodiments of the present disclosure and, together with the description, serve to explain the related principles.

### BRIEF DESCRIPTION OF THE DRAWINGS

Detailed discussion of embodiments directed to one of ordinary skill in the art is set forth in the specification, which makes reference to the appended figures, in which:

FIG. 1 depicts a block diagram of an example system for controlling the navigation of an autonomous vehicle according to example embodiments of the present disclosure;

FIG. 2 depicts a block diagram of an example computing system according to example embodiments of the present disclosure;

FIG. 3 depicts an example autonomous robot distribution request user interface according to example embodiments of the present disclosure;

FIG. 4 depicts an example autonomous robot distribution request user interface according to example embodiments of the present disclosure;

FIG. 5 depicts an example autonomous robot according to example embodiments of the present disclosure;

FIG. 6 depicts an example autonomous vehicle according to example embodiments of the present disclosure;

FIG. 7 depicts example positions within an autonomous vehicle according to example embodiments of the present disclosure;

FIG. 8 depicts an example interior cabin of an autonomous vehicle according to example embodiments of the present disclosure;

FIG. 9 depicts a flow diagram of example operations for autonomous robot distribution/delivery according to example embodiments of the present disclosure;

FIG. 10 depicts a flow diagram of example operations for autonomous robot retrieval according to example embodiments of the present disclosure; and

FIGS. 11A-11B depict flow diagrams of example operations of an autonomous robot distribution system according to example embodiments of the present disclosure.

### DETAILED DESCRIPTION

Reference now will be made in detail to embodiments, one or more example(s) of which are illustrated in the drawings. Each example is provided by way of explanation of the embodiments, not limitation of the present disclosure. In fact, it will be apparent to those skilled in the art that various modifications and variations can be made to the embodiments without departing from the scope of the present disclosure. For instance, features illustrated or described as part of one embodiment can be used with another embodiment to yield a still further embodiment. Thus, it is intended that aspects of the present disclosure cover such modifications and variations.

Example aspects of the present disclosure are directed to the management (e.g., distribution, delivery, retrieval, etc.) of an autonomous robot that provides for the distribution of goods (e.g., shipping, merchandising, etc.) in association with an autonomous vehicle. For example, an autonomous vehicle can be utilized to perform one or more vehicle services such as, for example, transportation services (e.g., rideshare services), courier services, delivery services, etc. To increase vehicle utilization, an autonomous vehicle can be configured to transport an autonomous robot in conjunction with other vehicle services, such as rideshare services, provided by a service entity (e.g., fleet manager, fleet owner, etc.). In particular, the systems and methods of the present disclosure can provide for the management (e.g., distribution, delivery, retrieval, etc.) by a service entity of one or more autonomous robots that are configured to transport one or more items in association with an autonomous vehicle.

The systems and methods of the present disclosure can allow for a service entity to provide for the movement/transportation (e.g., distribution, delivery, retrieval, etc.) of one or more autonomous robots that can be configured to transport one or more items based on a request, for example, from a user, such as a shipper, merchandiser, retailer, restaurant, supplier, consumer, and/or the like. According to an aspect of the present disclosure, a service entity can receive a request from a user (e.g., shipper, merchandiser, retailer, restaurant, supplier, consumer, etc.) to transport an autonomous robot from a starting location to a destination location via an autonomous vehicle, for example, through one or more user interfaces associated with the service entity (e.g., via a service entity application on a user computing device, etc.). An autonomous robot transport service can include, for example, retrieving an autonomous robot that has been loaded with one or more items and delivering the robot to a delivery destination (e.g., recipient's location, etc.); retrieving an autonomous robot loaded with one or more items that is to remain on the vehicle throughout a service period to allow for marketing and/or dispensing the one or more items to passengers using the vehicle; retrieving an autonomous robot from a prior delivery destination and returning it to a user and/or service entity storage location; retrieving an autonomous robot from a storage location and delivering it to a user for loading one or more items to be delivered; and/or the like. An operations computing system of a service entity can determine an autonomous vehicle to be assigned to transport the autonomous robot, for example, based on data associated with the autonomous robot transport service request, autonomous vehicle data (e.g., location, routing, assigned services, capacity, demand, etc.), historical data, demographic data, and/or the like. The operations computing system can provide data to the assigned autonomous vehicle and/or the autonomous robot to allow for the vehicle to proceed to the service starting location, allow the autonomous robot to board the autonomous vehicle, initiate vehicle travel according to the transport service request, and provide for the autonomous robot to disembark from the vehicle at a final destination. In this way, the infrastructure for managing the transport (e.g., distribution, delivery, retrieval, etc.) of autonomous robots in conjunction with a fleet of autonomous vehicles can improve vehicle utilization and service efficiency by allowing for more coordination of vehicle services (e.g., for delivery of goods and transport of passengers) as well as more efficient loading and unloading of autonomous robots (e.g., by moving an autonomous robot to more ideal positions along a route, etc.). Such improvements can reduce the impact on vehicle passengers and/or vehicle service travel time.

More particularly, a service entity (e.g., autonomous vehicle fleet operator, owner, manager, etc.) can use one or more vehicles (e.g., ground-based vehicles) to provide a vehicle service such as a transportation service (e.g., rideshare service), a courier service, a delivery service, and/or the like. The vehicle(s) can be autonomous vehicles that include various systems and devices configured to control the operation of the vehicle. For example, an autonomous vehicle can include an onboard vehicle computing system for operating the autonomous vehicle (e.g., located on or within the autonomous vehicle). The vehicle computing system can obtain sensor data from sensor(s) onboard the vehicle (e.g., cameras, LIDAR, RADAR), attempt to comprehend the vehicle's surrounding environment by performing various processing techniques on the sensor data, and generate an appropriate motion plan through the vehicle's surrounding environment. Moreover, an autonomous vehicle can be configured to communicate with one or more computing devices that are remote from the vehicle. For example, the autonomous vehicle can communicate with a remote computing system that can be associated with the service entity, such as the service entity's operations computing system. The operations computing system can include a plurality of system clients that can help the service entity monitor, communicate with, manage, etc. autonomous vehicles. In this way, the entity can manage the autonomous vehicles to provide the vehicle services of the entity.

In addition, an autonomous vehicle can be configured to transport one or more autonomous robots. As one example, the autonomous vehicle can be configured to transport autonomous robot(s) concurrently with one or more riders, passengers, etc., for instance, to increase utilization of the autonomous vehicle services and/or decrease per passenger transportation costs. In some implementations, the autonomous vehicle can be configured with one or more designated positions for an autonomous robot to be transported within the autonomous vehicle, such that the autonomous robot can board the autonomous vehicle and move to a designated position where it can be secured and interface with one or more of the autonomous vehicle systems.

An autonomous robot can be configured to provide one or more services, such as transporting, marketing, and/or dispensing one or more items. The items to be transported and/or dispensed by the autonomous robot can include, for example, food, electronics, part supplies, tools, flowers, mail, reading materials, toys, medications, toiletries, other perishable items, other non-perishable items, and/or the like. The autonomous robot can be configured with one or more compartments to transport items; with infrastructure to allow the autonomous robot to travel autonomously to and from an autonomous vehicle (e.g., from a starting location, to a destination location); and to interface with one or more systems of an autonomous vehicle.

An autonomous robot can be associated with one or more parties. For instance, in some implementations, an autonomous robot can be associated with a service entity. As an example, the service entity can provide for a user (e.g., shipper, merchandiser, retailer, restaurant, consumer, etc.) to use, lease, rent, and/or the like the autonomous robot to transport items associated with the user. In some implementations, the autonomous robot can be associated with a user (e.g., shipper, merchandiser, retailer, restaurant, consumer, etc.). The user can utilize the autonomous robot to transport, market, and/or dispense items. In some implementations, the autonomous robot can be associated with a third-party (e.g., not the service entity or user) which can provide (e.g., rent, lease, etc.) the autonomous robot to be utilized by one or more users (e.g., shipper, retailer, restaurant, consumer, etc.).

According to an aspect of the present disclosure, the systems and methods can provide for a service entity to provide for the transportation (e.g., distribution, delivery, retrieval, etc.) of one or more autonomous robots in conjunction with autonomous vehicles in the service entity's vehicle fleet. One or more user interfaces can be provided (e.g., via a mobile application, website, etc.) to allow a user (e.g., shipper, merchandiser, retailer, restaurant, supplier, consumer, etc.) to request the use of an autonomous robot and/or request the transport of an autonomous robot. For example, in some implementations, a user device (e.g., a personal computer, laptop, mobile phone, tablet, etc.) can present one or more user interfaces (e.g., via a display device) associated with the service entity. The user can provide user input (e.g., touch input, cursor input, text input, voice input, etc.) indicative of a pickup location and a destination location for an autonomous robot; a pickup time period and drop off time period for the autonomous robot; data associated with routing preferences for the autonomous robot (e.g., preferred route/passenger demographics for autonomous robots configured to market/dispense goods to vehicle passengers, etc.); the number of autonomous robots in a shipment group; requested vehicle infrastructure services (e.g., power requirements, communication requirements, temperature/humidity requirements, drainage requirements, etc.); identification data associated with the autonomous robot; and/or the like.

In some implementations, for instance where autonomous robots are configured to market and/or dispense items to passengers, the user can provide data indicate of a circulation area in which the user would like the service entity to transport the autonomous robot(s) during a service period (e.g., number of hours, days, etc.). For example, the user can provide data indicative of a circulation center location (e.g., physical address, GPS coordinates, etc.) and a circulation radius that describes the area in which the user would like the autonomous robot(s) to travel to market and/or dispense items to passengers. As another example, the user can provide data indicative of a geographical area (e.g., geo fence, neighborhood, street boundaries, etc.) that describes the area in which the user would like the autonomous robot(s) to travel to market and/or dispense items to passengers.

The operations computing system of the service entity can obtain (e.g., directly or indirectly) data that is based at least in part on the user input indicative of the requested autonomous robot service. For instance, the operations computing system can obtain data associated with a pickup location and destination location for an autonomous robot; data associated with a pickup time period and drop off time period for the autonomous robot; data associated with routing preferences for the autonomous robot (e.g., preferred route demographics for autonomous robots marketing/dispensing goods to vehicle passengers, etc.); the number of autonomous robots in a shipment group; requested vehicle infrastructure services (e.g., power requirements, communication requirements, temperature/humidity requirements, drainage requirements, etc.); identification data associated with the autonomous robot; and/or the like. In some implementations, the operations computing system can obtain historical service data (e.g., prior services data for routes/time periods, etc.), demographic data (e.g., user/passenger/location demographic data associated with routes, time periods, past services, etc.), vehicle demand prediction data (e.g., user/passenger demand predictions for given routes/time periods, etc.), capacity data (e.g., fleet capacity predictions for given routes/time periods given historical fleet data and existing service requests, etc.), user profile data, and/or the like for use in conjunction with the request data in determining timing and/or pricing for the requested autonomous robot service. In some implementations, the operations computing system can be configured to utilize this data to learn trends, demographics, and/or the like associated with routes, neighborhoods, users, and/or the like for use in improving vehicle selection, service timing (e.g., when requested services can be scheduled/provided), service pricing (e.g., estimated/actual costs for requested/completed services), etc.

The operations computing system can be configured to coordinate the transportation of an autonomous robot based at least in part on the data provided by the user device and the service entity's fleet. For instance, the operations computing system can obtain data associated with autonomous vehicle(s) in the entity vehicle fleet (e.g., demand, location, availability, capacity, routing, etc.) for use in determining one or more autonomous vehicles that can be assigned to provide the requested transport service for the autonomous robot. The operations computing system can select an available autonomous vehicle to be assigned to the requested autonomous robot service and generate data associated with the requested autonomous robot service (e.g., service assignment, etc.) at least based on the requested autonomous robot service and the selected autonomous vehicle. The data associated with the requested autonomous robot service (e.g., service assignment, etc.) can indicate, for example, a pickup location for the autonomous robot; a destination location for the autonomous robot; a time period for the service (e.g., pickup time range, drop off time range, etc.); route data for the autonomous robot service; identification data associated with the autonomous robot; requested vehicle infrastructure services; and/or the like. The operations computing system can provide the data associated with the requested autonomous robot service (e.g., service assignment, etc.) to the selected autonomous vehicle.

The operations computing system (and/or autonomous vehicle) can communicate with the autonomous robot to provide data associated with the transport service to the autonomous robot. For example, the autonomous robot can be provided with data associated with the service route and/or service timing such that the autonomous robot can travel to an appropriate location/position to efficiently board the autonomous vehicle. Additionally, or alternatively, the autonomous robot can be provided with data associated with the autonomous vehicle such as, for example, an identifier that can allow the autonomous robot to identify the autonomous vehicle (e.g., to help ensure that the robot locates and boards the correct autonomous vehicle).

As an example, a user (e.g., shipper, retailer, restaurant, supplier, etc.) can load one or more items onboard an autonomous robot (e.g., owned by the user, provided by the service entity, provided by a third party, etc.) that are to be transported to a delivery destination (e.g., recipient). The user can request a transport service (e.g., distribution, retrieval, etc.) for the autonomous robot from the service entity, for example, through a user interface associated with the service entity. The request can include, for example, a pickup location/time, a drop off location/time, routing preferences, requested vehicle infrastructure services for the autonomous robot, and/or the like. The service entity's operations computing system can select an autonomous vehicle within the service entity's fleet that can provide the requested autonomous robot service based on data associated with the service entity's vehicle fleet (e.g., demand data, capacity data, location of vehicles, routing, historical service data, etc.) along with data indicative of the autonomous robot service request. The operations computing system can generate an autonomous robot service assignment and provide data indicative of the autonomous robot service assignment to the selected autonomous vehicle and the autonomous vehicle can travel to a pickup location for the autonomous robot. The autonomous robot can move to the pickup location, identify the assigned autonomous vehicle at the pickup location (e.g., via sensor data analysis, robot to vehicle communication, etc.), and board the autonomous vehicle (e.g., using autonomy system(s) onboard the autonomous robot, etc.). The autonomous robot may move to a designated location in the cabin of the autonomous vehicle where it can be secured and interface with one or more infrastructure systems/services onboard the vehicle. The autonomous vehicle may then continue along an assigned route and, for example, make stops to allow one or more passengers to board or disembark from the autonomous vehicle. Upon reaching the delivery destination for the autonomous robot service, the autonomous robot may disengage from any vehicle infrastructure systems/services, disembark from the autonomous vehicle, and travel to the delivery location/position (e.g., using autonomy system(s) onboard the robot, etc.). The autonomous vehicle (and/or autonomous robot) may provide data indicative of the autonomous robot arrival at the destination location to the operations computing system, which may then provide service completion data to the user who requested the autonomous robot transport service.

Additionally, in some implementations, while onboard the autonomous vehicle, the autonomous robot may provide information to passengers in the autonomous vehicle cabin (e.g., via an interface onboard the autonomous robot, via an interface associated with the vehicle, via a user computing device application associated with the service entity, etc.) regarding one or more items available for purchase from the autonomous robot (e.g., onboard the autonomous robot in one or more compartments, etc.) and provide for dispensing purchased item(s) to passenger(s). In some implementations, a service entity may select an autonomous vehicle to be assigned for a requested service from a passenger (rideshare service, etc.) based on whether a vehicle is transporting an autonomous robot having purchasable items onboard. For example, based in part on data associated with the requesting user, a service entity may select from multiple autonomous vehicles nearby the service starting location by determining whether one of the vehicles is transporting an autonomous robot that is carrying item(s) that the passenger may wish to purchase.

In some implementations, one or more autonomous robots can be loaded onto an autonomous vehicle before the autonomous vehicle is made available to riders, passengers, and/or the like for transportation services (e.g., rideshare services, etc.). In some implementations, the autonomous vehicle can proceed to the rider/passenger destination and allow the rider(s)/passenger(s) to disembark before proceeding to the delivery destination for the autonomous robot(s). In some implementations, the autonomous robot(s) can remain on the autonomous vehicle throughout the service period (e.g., several hours, business day, full day, etc.) allowing the autonomous robot(s) to market and/or dispense items carried by the autonomous robot(s) to riders, passengers, and/or the like who board the autonomous vehicle throughout the service period.

In some implementations, for example, where the autonomous robots are owned and/or managed by a user, such as a shipper, retailer, and/or the like, or other third party (e.g., autonomous robot provider), the service entity may provide a more robust and/or dedicated user interface customized to the user/third party's requirements. In some implementations, for example, where the autonomous robot is configured to market and/or dispense items to riders in the autonomous vehicle, the entity may provide some level of vehicle service/route historical data and/or demographic data to the user (e.g., shipper, retailer, etc.) when the user is requesting an autonomous robot service (e.g., for use in selecting routes, destinations, etc.).

In some implementations, the service entity can provide for retrieving an autonomous robot from a prior delivery location (e.g., from a delivery recipient once onboard items have been unloaded, etc.) and returning the autonomous robot to the user, other third party, and/or service entity location (e.g., storage facility, etc.). For example, the operations computing system can receive data indicating that a previously delivered autonomous robot is ready for retrieval (e.g., from the autonomous robot, from the recipient, from the user/third party associated with the autonomous robot, etc.) at a prior delivery location (e.g., a destination location of an earlier autonomous robot distribution service provided by the service entity, etc.). The operations computing system can select an autonomous vehicle within the service entity's fleet that can retrieve the autonomous robot based at least in part on data associated with the service entity's vehicle fleet along with data associated with the autonomous robot and/or an autonomous robot retrieval service request (e.g., current location, pickup time period, robot identification, etc.). The operations computing system can generate a retrieval service assignment and provide data indicative of the retrieval service assignment to the selected autonomous vehicle. The autonomous vehicle can travel to a retrieval/pickup location for the autonomous robot and provide for the autonomous robot to board the autonomous vehicle. The autonomous robot can move to the retrieval/pickup location, identify the assigned autonomous vehicle (e.g., via sensor data analysis, robot to vehicle communication, etc.), and board the autonomous vehicle (e.g., using autonomy system(s) onboard the autonomous robot, etc.). The autonomous robot may move to a designated location in the cabin of the autonomous vehicle where it can be secured and interface with one or more infrastructure systems/services onboard the vehicle. Upon reaching the user/third party/service entity destination, the autonomous robot may disengage from any vehicle infrastructure systems/services, disembark from the autonomous vehicle, and travel to a designated location/position (e.g., using autonomy system(s) onboard the robot, etc.).

Various means can be configured to perform the methods and processes described herein. For example, a computing system can include transport request data obtaining unit(s), vehicle/fleet data obtaining unit(s), vehicle selection unit(s), service assignment generation unit(s), vehicle/robot communication unit(s), and/or other means for performing the operations and functions described herein. In some implementations, one or more of the units may be implemented separately. In some implementations, one or more units may be a part of or included in one or more other units. These means can include processor(s), microprocessor(s), graphics processing unit(s), logic circuit(s), dedicated circuit(s), application-specific integrated circuit(s), programmable array logic, field-programmable gate array(s), controller(s), microcontroller(s), and/or other suitable hardware. The means can also, or alternately, include software control means implemented with a processor or logic circuitry, for example. The means can include or otherwise be able to access memory such as, for example, one or more non-transitory computer-readable storage media, such as random-access memory, read-only memory, electrically erasable programmable read-only memory, erasable programmable read-only memory, flash/other memory device(s), data registrar(s), database(s), and/or other suitable hardware.

The means can be programmed to perform one or more algorithm(s) for carrying out the operations and functions described herein. For instance, the means can be configured to obtain data indicative of an autonomous robot transport service request from a user. In some implementations, the means can be configured to receive the service request data from a user and provide the service request data to one or more computing systems. A transport request data obtaining unit is one example of means for obtaining data indicative of an autonomous robot transport service request as described herein.

The means can be configured to obtain data associated with a service entity vehicle fleet and/or one or more autonomous vehicles. For example, the means can be configured to obtain data associated with a service entity autonomous vehicle fleet such as demand data, capacity data, vehicle location data, vehicle routing, historical service data, demographic data, and/or the like for use in determining vehicle availability for providing autonomous robot transport services. A vehicle/fleet data obtaining unit is one example of a means for obtaining data associated with a service entity's autonomous vehicle fleet, as described herein.

The means can be configured to select an autonomous vehicle to provide a requested autonomous robot transport service. For example, based on obtaining data indicative of an autonomous robot transport service request and data associated with a service entity vehicle fleet, the means can be configured to determine and select an autonomous vehicle within the service entity fleet that can be assigned to provide the autonomous robot transport service. A vehicle selection unit is one example of a means for selecting an autonomous vehicle for an autonomous robot transport service, as described herein.

The means can be configured to generate an autonomous robot service assignment for a selected autonomous vehicle. The means can be configured to generate an autonomous robot service assignment based in part on the autonomous robot transport service request which can be provided to a selected autonomous vehicle and allow for the autonomous vehicle to provide the autonomous robot service. For example, the means can generate data indicative of a service assignment including, for example, a pickup location, pickup time frame, destination location destination time frame, routing, an autonomous robot identifier, requested vehicle infrastructure services, and/or the like. A service assignment generation unit is one example of a means for generating an autonomous robot service assignment, as described herein.

The means can be configured to provide data indicative of the autonomous robot service assignment to the autonomous vehicle and/or the autonomous robot, for example, to allow for the provisioning of the autonomous robot transport service by the autonomous vehicle. A vehicle/robot communication unit is one example of a means for providing the data indicative of the autonomous robot service assignment, as described herein.

The systems and methods described herein provide a number of technical effects and benefits. For instance, the systems and methods can provide for managing the distribution of autonomous robots in conjunction with autonomous vehicles in a fleet, thereby achieving improvements in vehicle utilization, reductions in per user costs, and efficiency improvements in the transportation and/or delivery of goods. Such improvements can be provided, for example, by allowing for more efficient loading and unloading of the autonomous robot (e.g., by moving the autonomous robot to more ideal positions along a route, etc.) such that it reduces the impact on the vehicle passenger(s) and/or vehicle travel time.

The systems and methods described herein also provide resulting improvements to computing technology tasked with operation relative to the disclosed delivery systems and methods. For instance, the use of systems to manage autonomous robots in conjunction with autonomous vehicle such as described herein can ultimately lead to improved delivery of goods and transport of passengers. For instance, the systems of the present technology can allow for leveraging service entity computing system resources and autonomous vehicle resources to provide improved transport and delivery of items, while increasing vehicle fleet utilization and/or decreasing passenger cost. For example, a service entity computing system can be configured to obtain data associated with a request for an autonomous robot transport service and determine availability of one or more autonomous vehicles for the autonomous robot transport service based at least in part on the request for the autonomous robot transport service. The computing system can select an autonomous vehicle to provide transport of an autonomous robot associated with the autonomous robot transport service based at least in part on the availability of one or more autonomous vehicles and the data associated with the request for the autonomous robot transport service. The computing system can generate an autonomous robot service assignment for the selected autonomous vehicle based at least in part on the data associated with the request for the autonomous robot transport service. The computing system can provide data indicative of the autonomous robot service assignment to the selected autonomous vehicle. Accordingly, the disclosed systems can allow for a service entity computing system to efficiently assign requested autonomous robot transport services to autonomous vehicles based on a variety of parameters. This allows for efficient use of system resources for transport and delivery services while increasing vehicle utilization. Thus, the disclosed systems provide for a more efficient use of resources to provide item transport and delivery, as well as reduced passenger costs, without providing a burden to autonomous vehicle passengers.

With reference to the figures, example embodiments of the present disclosure will be discussed in further detail.

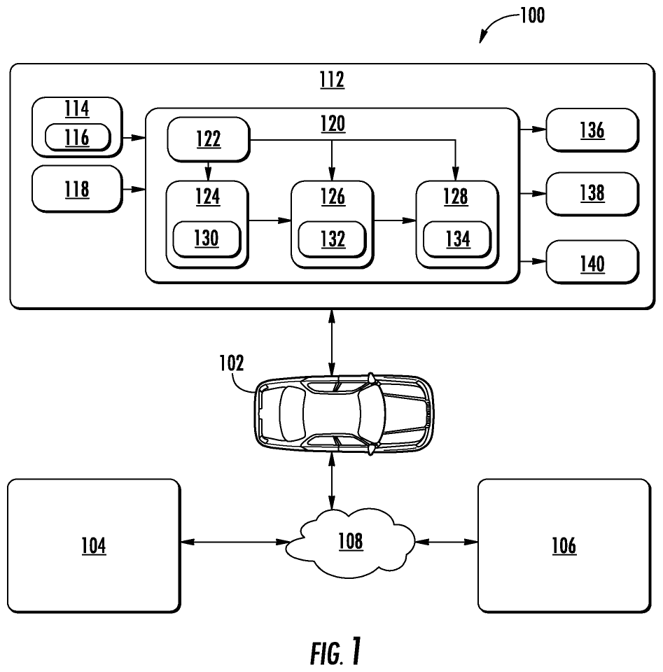

FIG. 1 depicts a block diagram of an example system 100 for controlling the navigation of an autonomous vehicle according to example embodiments of the present disclosure. As illustrated, FIG. 1 shows a system 100 that can include a vehicle 102; an operations computing system 104; one or more remote computing devices 106; a communication network 108; a vehicle computing system 112; one or more autonomy system sensors 114; autonomy system sensor data 116; a positioning system 118; an autonomy computing system 120; map data 122; a perception system 124; a prediction system 126; a motion planning system 128; state data 130; prediction data 132; motion plan data 134; a communication system 136; a vehicle control system 138; and a human-machine interface 140.

The operations computing system 104 can be associated with a service entity that can provide one or more vehicle services to a plurality of users, passengers, riders, etc. via a fleet of vehicles that includes, for example, the vehicle 102. The vehicle services can include transportation services (e.g., rideshare services), courier services, delivery services, and/or other types of services.

The operations computing system 104 can include multiple components for performing various operations and functions. For example, the operations computing system 104 can include and/or otherwise be associated with the one or more computing devices that are remote from the vehicle 102. The one or more computing devices of the operations computing system 104 can include one or more processors and one or more memory devices. The one or more memory devices of the operations computing system 104 can store instructions that when executed by the one or more processors cause the one or more processors to perform operations and functions associated with operation of one or more vehicles (e.g., a fleet of vehicles), with the provision of vehicle services, the transport, delivery, and/or retrieval of autonomous robots, and/or other operations as discussed herein.

For example, the operations computing system 104 can be configured to monitor and communicate with the vehicle 102 and/or its users to coordinate a vehicle service provided by the vehicle 102. To do so, the operations computing system 104 can manage a database that includes data including vehicle status data associated with the status of vehicles including the vehicle 102. The vehicle status data can include a state of a vehicle, a location of a vehicle (e.g., a latitude and longitude of a vehicle), the availability of a vehicle (e.g., whether a vehicle is available to pick-up or drop-off passengers and/or cargo, etc.), the status of one or more vehicle systems, the status of one or more autonomous robots, and/or the state of objects internal and/or external to a vehicle (e.g., the physical dimensions and/or appearance of objects internal/external to the vehicle).

The operations computing system 104 can communicate with the one or more remote computing devices 106 and/or the vehicle 102 via one or more communications networks including the communications network 108. The communications network 108 can exchange (send or receive) signals (e.g., electronic signals) or data (e.g., data from a computing device) and include any combination of various wired (e.g., twisted pair cable) and/or wireless communication mechanisms (e.g., cellular, wireless, satellite, microwave, and radio frequency) and/or any desired network topology (or topologies). For example, the communications network 108 can include a local area network (e.g. intranet), wide area network (e.g. Internet), wireless LAN network (e.g., via Wi-Fi), cellular network, a SATCOM network, VHF network, a HF network, a WiMAX based network, and/or any other suitable communications network (or combination thereof) for transmitting data to and/or from the vehicle 102.

Each of the one or more remote computing devices 106 can include one or more processors and one or more memory devices. The one or more memory devices can be used to store instructions that when executed by the one or more processors of the one or more remote computing devise 106 cause the one or more processors to perform operations and/or functions including operations and/or functions associated with the vehicle 102 including exchanging (e.g., sending and/or receiving) data or signals with the vehicle 102, monitoring the state of the vehicle 102, and/or controlling the vehicle 102; operations and/or functions associated with one or more autonomous robots; and/or the like. The one or more remote computing devices 106 can communicate (e.g., exchange data and/or signals) with one or more devices including the operations computing system 104 and the vehicle 102 via the communications network 108.

The one or more remote computing devices 106 can include one or more computing devices (e.g., a desktop computing device, a laptop computing device, a smart phone, and/or a tablet computing device) that can receive input or instructions from a user or exchange signals or data another computing device or computing system (e.g., the operations computing system 104). Further, the one or more remote computing devices 106 can be used to determine and/or modify one or more states of the vehicle 102 including a location (e.g., a latitude and longitude), a velocity, acceleration, a trajectory, and/or a path of the vehicle 102 based in part on signals or data exchanged with the vehicle 102. In some implementations, the operations computing system 104 can include the one or more remote computing devices 106.

The vehicle 102 can be a ground-based vehicle (e.g., an automobile, truck, etc.), an aircraft, and/or another type of vehicle. The vehicle 102 can be an autonomous vehicle that can perform various actions including driving, navigating, and/or operating, with minimal and/or no interaction from a human driver. The autonomous vehicle 102 can be configured to operate in one or more modes including, for example, a fully autonomous operational mode, a semi-autonomous operational mode, a park mode, a sleep mode, and/or the like. A fully autonomous (e.g., self-driving) operational mode can be one in which the vehicle 102 can provide driving and navigational operation with minimal and/or no interaction from a human driver present in the vehicle. A semi-autonomous operational mode can be one in which the vehicle 102 can operate with some interaction from a human driver present in the vehicle. Park and/or sleep modes can be used between operational modes while the vehicle 102 performs various actions including waiting to provide a subsequent vehicle service, and/or recharging between operational modes.

An indication, record, and/or other data indicative of the state of the vehicle, the state of one or more passengers of the vehicle, the state of one or more autonomous robots, and/or the state of an environment including one or more objects (e.g., the physical dimensions and/or appearance of the one or more objects) can be stored locally in one or more memory devices of the vehicle 102. Additionally, the vehicle 102 can provide data indicative of the state of the vehicle, the state of one or more passengers of the vehicle, the state of one or more autonomous robots, and/or the state of an environment to the operations computing system 104, which can store an indication, record, and/or other data indicative of the state of the vehicle, the state of one or more passengers of the vehicle, the state of one or more autonomous robots, and/or the state of an environment in one or more memory devices associated with the operations computing system 104 (e.g., remote from the vehicle). Furthermore, the vehicle 102 can provide data indicative of the state of the one or more objects (e.g., physical dimensions and/or appearance of the one or more objects) within a predefined distance of the vehicle 102 to the operations computing system 104, which can store an indication, record, and/or other data indicative of the state of the one or more objects within a predefined distance of the vehicle 102 in one or more memory devices associated with the operations computing system 104 (e.g., remote from the vehicle).

The vehicle 102 can include and/or be associated with the vehicle computing system 112. The vehicle computing system 112 can include one or more computing devices located onboard the vehicle 102. For example, the one or more computing devices of the vehicle computing system 112 can be located on and/or within the vehicle 102. The one or more computing devices of the vehicle computing system 112 can include various components for performing various operations and functions. For instance, the one or more computing devices of the vehicle computing system 112 can include one or more processors and one or more tangible, non-transitory, computer readable media (e.g., memory devices). The one or more tangible, non-transitory, computer readable media can store instructions that when executed by the one or more processors cause the vehicle 102 (e.g., its computing system, one or more processors, and other devices in the vehicle 102) to perform operations and functions, including those described herein.

As depicted in FIG. 1, the vehicle computing system 112 can include the one or more autonomy system sensors 114; the positioning system 118; the autonomy computing system 120; the communication system 136; the vehicle control system 138; and the human-machine interface 140. One or more of these systems can be configured to communicate with one another via a communication channel. The communication channel can include one or more data buses (e.g., controller area network (CAN)), on-board diagnostics connector (e.g., OBD-II), and/or a combination of wired and/or wireless communication links. The onboard systems can exchange (e.g., send and/or receive) data, messages, and/or signals amongst one another via the communication channel.

The one or more autonomy system sensors 114 can be configured to generate and/or store data including the autonomy sensor data 116 associated with one or more objects that are proximate to the vehicle 102 (e.g., within range or a field of view of one or more of the one or more sensors 114). The one or more autonomy system sensors 114 can include a Light Detection and Ranging (LIDAR) system, a Radio Detection and Ranging (RADAR) system, one or more cameras (e.g., visible spectrum cameras and/or infrared cameras), motion sensors, and/or other types of imaging capture devices and/or sensors. The autonomy sensor data 116 can include image data, radar data, LIDAR data, and/or other data acquired by the one or more autonomy system sensors 114. The one or more objects can include, for example, pedestrians, vehicles, bicycles, and/or other objects. The one or more sensors can be located on various parts of the vehicle 102 including a front side, rear side, left side, right side, top, or bottom of the vehicle 102. The autonomy sensor data 116 can be indicative of locations associated with the one or more objects within the surrounding environment of the vehicle 102 at one or more times. For example, autonomy sensor data 116 can be indicative of one or more LIDAR point clouds associated with the one or more objects within the surrounding environment. The one or more autonomy system sensors 114 can provide the autonomy sensor data 116 to the autonomy computing system 120.

In addition to the autonomy sensor data 116, the autonomy computing system 120 can retrieve or otherwise obtain data including the map data 122. The map data 122 can provide detailed information about the surrounding environment of the vehicle 102. For example, the map data 122 can provide information regarding: the identity and location of different roadways, road segments, buildings, or other items or objects (e.g., lampposts, crosswalks and/or curb); the location and directions of traffic lanes (e.g., the location and direction of a parking lane, a turning lane, a bicycle lane, or other lanes within a particular roadway or other travel way and/or one or more boundary markings associated therewith); traffic control data (e.g., the location and instructions of signage, traffic lights, or other traffic control devices); and/or any other map data that provides information that assists the vehicle computing system 112 in processing, analyzing, and perceiving its surrounding environment and its relationship thereto.

The vehicle computing system 112 can include a positioning system 118. The positioning system 118 can determine a current position of the vehicle 102. The positioning system 118 can be any device or circuitry for analyzing the position of the vehicle 102. For example, the positioning system 118 can determine position by using one or more of inertial sensors, a satellite positioning system, based on IP/MAC address, by using triangulation and/or proximity to network access points or other network components (e.g., cellular towers and/or Wi-Fi access points) and/or other suitable techniques. The position of the vehicle 102 can be used by various systems of the vehicle computing system 112 and/or provided to one or more remote computing devices (e.g., the operations computing system 104 and/or the remote computing device 106). For example, the map data 122 can provide the vehicle 102 relative positions of the surrounding environment of the vehicle 102. The vehicle 102 can identify its position within the surrounding environment (e.g., across six axes) based at least in part on the data described herein. For example, the vehicle 102 can process the autonomy sensor data 116 (e.g., LIDAR data, camera data) to match it to a map of the surrounding environment to get an understanding of the vehicle's position within that environment (e.g., transpose the vehicle's position within its surrounding environment).

The autonomy computing system 120 can include a perception system 124, a prediction system 126, a motion planning system 128, and/or other systems that cooperate to perceive the surrounding environment of the vehicle 102 and determine a motion plan for controlling the motion of the vehicle 102 accordingly. For example, the autonomy computing system 120 can receive the autonomy sensor data 116 from the one or more autonomy system sensors 114, attempt to determine the state of the surrounding environment by performing various processing techniques on the autonomy sensor data 116 (and/or other data), and generate an appropriate motion plan through the surrounding environment. The autonomy computing system 120 can control the one or more vehicle control systems 138 to operate the vehicle 102 according to the motion plan.

The perception system 124 can identify one or more objects that are proximate to the vehicle 102 (e.g., within a sensors field of view, range, etc.) based on autonomy sensor data 116 received from the autonomy system sensors 114. In particular, in some implementations, the perception system 124 can determine, for each object, state data 130 that describes a current state of such object. As examples, the state data 130 for each object can describe an estimate of the object's: current location (also referred to as position); current speed; current heading (which may also be referred to together as velocity); current acceleration; current orientation; size/footprint (e.g., as represented by a bounding shape such as a bounding polygon or polyhedron); class of characterization (e.g., vehicle class versus pedestrian class versus bicycle class versus other class); yaw rate; and/or other state information. In some implementations, the perception system 124 can determine state data 130 for each object over a number of iterations. In particular, the perception system 124 can update the state data 130 for each object at each iteration. Thus, the perception system 124 can detect and track objects (e.g., vehicles, bicycles, pedestrians, etc.) that are proximate to the vehicle 102 over time, and thereby produce a presentation of the world around an vehicle 102 along with its state (e.g., a presentation of the objects of interest within a scene at the current time along with the states of the objects).

The prediction system 126 can receive the state data 130 from the perception system 124 and predict one or more future locations and/or moving paths for each object based on such state data. For example, the prediction system 126 can generate prediction data 132 associated with each of the respective one or more objects proximate to the vehicle 102. The prediction data 132 can be indicative of one or more predicted future locations of each respective object. The prediction data 132 can be indicative of a predicted path (e.g., predicted trajectory) of at least one object within the surrounding environment of the vehicle 102. For example, the predicted path (e.g., trajectory) can indicate a path along which the respective object is predicted to travel over time (and/or the velocity at which the object is predicted to travel along the predicted path). The prediction system 126 can provide the prediction data 132 associated with the one or more objects to the motion planning system 128.

The motion planning system 128 can determine a motion plan and generate motion plan data 134 for the vehicle 102 based at least in part on the prediction data 132 (the state data 130 and/or other data). The motion plan data 134 can include vehicle actions with respect to the objects proximate to the vehicle 102 as well as the predicted movements. For instance, the motion planning system 128 can implement an optimization algorithm that considers cost data associated with a vehicle action as well as other objective functions (e.g., cost functions based on speed limits, traffic lights, and/or other aspects of the environment), if any, to determine optimized variables that make up the motion plan data 134. By way of example, the motion planning system 128 can determine that the vehicle 102 can perform a certain action (e.g., pass an object) without increasing the potential risk to the vehicle 102 and/or violating any traffic laws (e.g., speed limits, lane boundaries, signage). The motion plan data 134 can include a planned trajectory, velocity, acceleration, and/or other actions of the vehicle 102.

As one example, in some implementations, the motion planning system 128 can determine a cost function for each of one or more candidate motion plans for the autonomous vehicle 102 based at least in part on the current locations and/or predicted future locations and/or moving paths of the objects. For example, the cost function can describe a cost (e.g., over time) of adhering to a particular candidate motion plan. For example, the cost described by a cost function can increase when the autonomous vehicle 102 approaches impact with another object and/or deviates from a preferred pathway (e.g., a predetermined travel route).

Thus, given information about the current locations and/or predicted future locations and/or moving paths of objects, the motion planning system 128 can determine a cost of adhering to a particular candidate pathway. The motion planning system 128 can select or determine a motion plan for the autonomous vehicle 102 based at least in part on the cost function(s). For example, the motion plan that minimizes the cost function can be selected or otherwise determined. The motion planning system 128 then can provide the selected motion plan to a vehicle controller that controls one or more vehicle controls (e.g., actuators or other devices that control gas flow, steering, braking, etc.) to execute the selected motion plan.

The motion planning system 128 can provide the motion plan data 134 with data indicative of the vehicle actions, a planned trajectory, and/or other operating parameters to the vehicle control systems 138 to implement the motion plan data 134 for the vehicle 102. For instance, the vehicle 102 can include a mobility controller configured to translate the motion plan data 134 into instructions. By way of example, the mobility controller can translate a determined motion plan data 134 into instructions for controlling the vehicle 102 including adjusting the steering of the vehicle 102 “X” degrees and/or applying a certain magnitude of braking force. The mobility controller can send one or more control signals to the responsible vehicle control component (e.g., braking control system, steering control system and/or acceleration control system) to execute the instructions and implement the motion plan data 134.

The vehicle computing system 112 can include a communications system 136 configured to allow the vehicle computing system 112 (and its one or more computing devices) to communicate with other computing devices. The vehicle computing system 112 can use the communications system 136 to communicate with the operations computing system 104 and/or one or more other remote computing devices (e.g., the one or more remote computing devices 106) over one or more networks (e.g., via one or more wireless signal connections, etc.). In some implementations, the communications system 136 can allow communication among one or more of the systems onboard the vehicle 102. The communications system 136 can also be configured to enable the autonomous vehicle to communicate with and/or provide and/or receive data and/or signals from a remote computing device 106 associated with a user, an item (e.g., an item to be picked-up for a courier service), an autonomous robot, and/or the like. The communications system 136 can utilize various communication technologies including, for example, radio frequency signaling and/or Bluetooth low energy protocol. The communications system 136 can include any suitable components for interfacing with one or more networks, including, for example, one or more: transmitters, receivers, ports, controllers, antennas, and/or other suitable components that can help facilitate communication. In some implementations, the communications system 136 can include a plurality of components (e.g., antennas, transmitters, and/or receivers) that allow it to implement and utilize multiple-input, multiple-output (MIMO) technology and communication techniques.

The vehicle computing system 112 can include the one or more human-machine interfaces 140. For example, the vehicle computing system 112 can include one or more display devices located on the vehicle computing system 112. A display device (e.g., screen of a tablet, laptop, and/or smartphone) can be viewable by a user of the vehicle 102 that is located in the front of the vehicle 102 (e.g., operator's seat, etc.). Additionally, or alternatively, a display device can be viewable by a user of the vehicle 102 that is located in the rear of the vehicle 102 (e.g., a passenger seat).

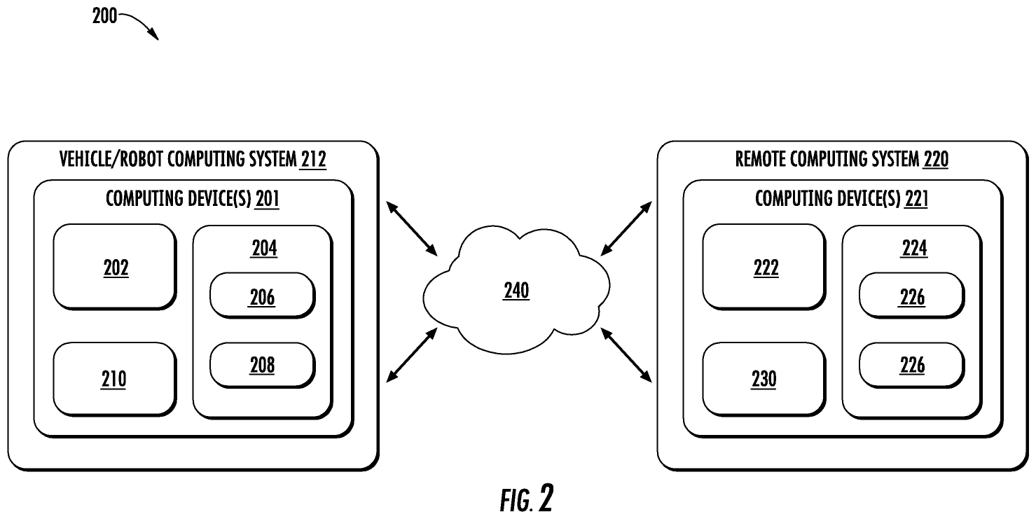

FIG. 2 depicts a block diagram of an example computing system 200 according to example embodiments of the present disclosure. The example system 200 illustrated in FIG. 2 is provided as an example only. The components, systems, connections, and/or other aspects illustrated in FIG. 2 are optional and are provided as examples of what is possible, but not required, to implement the present disclosure. The example system 200 can include a vehicle computing system and/or autonomous robot computing system 212 and a remote computing system 220 (e.g., operations computing system, other computing system, etc. that is remote from the vehicle 102 and/or autonomous robot 500) that can be communicatively coupled to one another over one or more network(s) 240. The remote computing system 220 can be and/or include the operations computing system 104 and/or remote computing system 106 of FIG. 1. The remote computing system 220 can be associated with an operations computing system and/or an entity associated with the vehicle 102 such as, for example, a vehicle owner, vehicle manager, fleet operator, service provider, etc. For instance, the remote computing system 220 can be or otherwise include the operations computing system 104 (and/or remote computing device(s) 106) described herein.

The computing device(s) 201 of the vehicle/robot computing system 212 can include processor(s) 202 and at least one memory 204. The one or more processors 202 can be any suitable processing device (e.g., a processor core, a microprocessor, an ASIC, a FPGA, a controller, a microcontroller, etc.) and can be one processor or a plurality of processors that are operatively connected. The memory 204 can include one or more non-transitory computer-readable storage media, such as RAM, ROM, EEPROM, EPROM, one or more memory devices, flash memory devices, magnetic disks, data registers, etc., and combinations thereof

The memory 204 can store information that can be accessed by the one or more processors 202. For instance, the memory 204 (e.g., one or more non-transitory computer-readable storage mediums, memory devices) can include computer-readable instructions 206 that can be executed by the one or more processors 202. The instructions 206 can be software written in any suitable programming language or can be implemented in hardware. Additionally, or alternatively, the instructions 206 can be executed in logically and/or virtually separate threads on processor(s) 202.

For example, the memory 204 on-board the vehicle 102 and/or autonomous robot can store instructions 206 that when executed by the one or more processors 202 cause the one or more processors 202 to perform operations such as any of the operations and functions of a vehicle and/or robot as described herein, the computing device(s) 201, and/or vehicle/robot computing system 212, any of the operations and functions for which the vehicle/robot computing system 212 is configured, one or more portions of the methods 900, 1000, 1100 as further described herein, and/or any other operations and functions described herein.

The memory 204 can store data 208 that can be obtained (e.g., received, accessed, written, manipulated, created, generated, etc.) and/or stored. The data 208 can include, for instance, services data (e.g., trip data, route data, user data, infrastructure system requirement data, etc.), sensor data, map data, perception data, prediction data, motion planning data, object states and/or state data, object motion trajectories, item inventory data, log data, and/or other data/information as described herein. In some implementations, the computing device(s) 201 can obtain data from one or more memories that are remote from the vehicle/robot computing system 212.

The computing device(s) 201 can also include a communication interface 210 used to communicate with one or more other system(s) (e.g., the remote computing system 220).

The communication interface 210 can include any circuits, components, software, etc. for communicating via one or more networks (e.g., network(s) 240). In some implementations, the communication interface 210 can include, for example, one or more of a communications controller, receiver, transceiver, transmitter, port, conductors, software, and/or hardware for communicating data.

The remote computing system 220 can include one or more computing device(s) 221. The computing device(s) 221 can include one or more processors 222 and at least one memory 224. The one or more processors 222 can be any suitable processing device (e.g., a processor core, a microprocessor, an ASIC, a FPGA, a controller, a microcontroller, etc.) and can be one processor or a plurality of processors that are operatively connected. The memory 224 can include one or more tangible, non-transitory computer-readable storage media, such as RAM, ROM, EEPROM, EPROM, one or more memory devices, flash memory devices, data registers, etc., and combinations thereof

The memory 224 can store information that can be accessed by the one or more processors 222. For instance, the memory 224 (e.g., one or more tangible, non-transitory computer-readable storage media, one or more memory devices, etc.) can include computer-readable instructions 226 that can be executed by the one or more processors 222. The instructions 226 can be software written in any suitable programming language or can be implemented in hardware. Additionally, or alternatively, the instructions 226 can be executed in logically and/or virtually separate threads on processor(s) 222.

For example, the memory 224 can store instructions 226 that when executed by the one or more processors 222 cause the one or more processors 222 to perform operations such as any of the operations and functions of the operations computing system 104, the remote computing system 106, the remote computing system 220 and/or computing device(s) 221, or for which any of these computing systems are configured, as described herein, one or more portions of the methods 900, 1000, 1100 as further described herein, and/or any other operations and functions described herein.

The memory 224 can store data 228 that can be obtained and/or stored. The data 228 can include, for instance, services data (e.g., trip data, route data, user data, infrastructure system requirement data, etc.), data associated with autonomous vehicles (e.g., vehicle data, maintenance data, ownership data, sensor data, map data, perception data, prediction data, motion planning data, object states and/or state data, object motion trajectories, feedback data, log data, etc.), data associated with autonomous robots (e.g., ownership data, sensor data, infrastructure system requirement data, onboard inventory data, log data, etc.), third-party entity data, inventory data, scheduling data, log data, and/or other data/information as described herein. In some implementations, the computing device(s) 221 can obtain data from one or more memories that are remote from the remote computing system 220.

The computing device(s) 221 can also include a communication interface 230 used to communicate with one or more other system(s) (e.g., the vehicle/robot computing system 212, etc.). The communication interface 230 can include any circuits, components, software, etc. for communicating via one or more networks (e.g., network(s) 240). In some implementations, the communication interface 230 can include, for example, one or more of a communications controller, receiver, transceiver, transmitter, port, conductors, software, and/or hardware for communicating data.

The network(s) 240 can be any type of network or combination of networks that allows for communication between devices. In some embodiments, the network(s) 240 can include one or more of a local area network, wide area network, the Internet, secure network, cellular network, mesh network, peer-to-peer communication link, and/or some combination thereof, and can include any number of wired or wireless links. Communication over the network(s) 240 can be accomplished, for instance, via a communication interface using any type of protocol, protection scheme, encoding, format, packaging, etc.

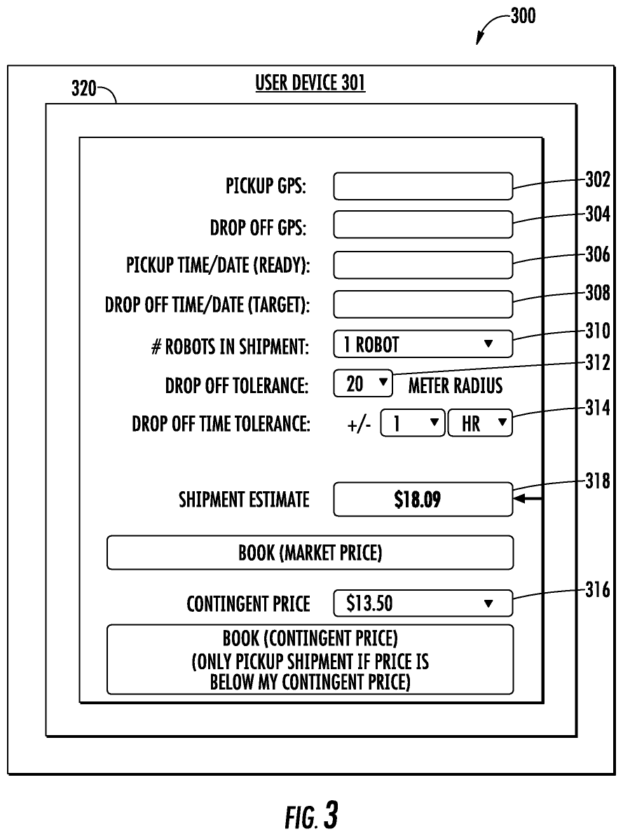

FIG. 3 depicts an example of an autonomous robot distribution request user interface 300 that can provide for requesting an autonomous robot distribution service for delivery of items onboard autonomous robot(s) according to example embodiments of the present disclosure. A service entity can provide for the transport (e.g., distribution, delivery, retrieval, etc.) of one or more autonomous robots (e.g., autonomous robot 500, etc.) in conjunction with autonomous vehicles (e.g., autonomous vehicles 102, 600, etc.) in the service entity's vehicle fleet. One or more user interfaces can be provided (e.g., via a mobile application, website, etc.) to allow a user (e.g., shipper, retailer, restaurant, supplier, consumer, etc.) to request the use of an autonomous robot (e.g., autonomous robot 500, etc.) and/or request the transport of an autonomous robot (e.g., autonomous robot 500, etc.). For example, in some implementations, a user device 301 (e.g., a personal computer, laptop, mobile phone, tablet, etc.) can present (e.g., via a display device 320) one or more user interfaces associated with the service entity.

As illustrated in FIG. 3, distribution request user interface 300 provides an example of a user interface allowing for user input of data associated with a distribution service request to transport an autonomous robot (e.g., autonomous robot 500, etc.) to a delivery location (e.g., recipient location, etc.). For example, distribution request user interface 300 can allow for input of data associated with a pickup location 302 (e.g., a physical address, GPS coordinates, semantic place name, etc. indicative of a start location for the requested service) and a drop off location 304 (e.g., a physical address, GPS coordinates, semantic place name, etc. indicative of a destination location for the requested service). Distribution request user interface 300 can allow for input of data associated with a pickup time/date 306 (e.g., a time/date when the autonomous robot will be available to be transported for the requested service) and a drop off time/date 308 (e.g., a target time/date when the user would like the autonomous robot to arrive at the service destination location). Distribution request user interface 300 can allow for input of data associated with a number of autonomous robots 310 to be included in the requested distribution service (e.g., one or more autonomous robots may be included in the requested distribution service). Distribution request user interface 300 can allow for input of data associated with a drop off tolerance 312, which may be indicative of a distance range from the drop off location 304 that would be acceptable for the autonomous robot to be dropped off by an autonomous vehicle (e.g., an acceptable radius around the drop off location, etc.). Distribution request user interface 300 can allow for input of data associated with a drop off time tolerance 314, which may be indicative of a time period around the requested drop off time/date 308 that would be acceptable to the user for the autonomous robot to be delivered to the destination location (e.g., a number of hours, minutes, days, etc. before/after the requested drop off time/date in which the autonomous robot can be delivered, etc.). Distribution request user interface 300 can allow for input of data associated with a contingent price 316, which may be indicative of a maximum cost that the user will accept for the requested service.

The service entity (e.g., via an operations computing system, etc.) may determine a shipment estimate 318 indicative of an estimated cost for the requested distribution service. The estimated cost may be determined based at least in part on the distribution service request data input by the user (e.g., in distribution request user interface 300). The actual cost of a completed distribution service may be higher or lower than the shipment estimate 318. In some implementations, the service entity (e.g., via an operations computing system, etc.) can obtain historical service data (e.g., prior services data for routes/time periods, etc.), demographic data (e.g., user/passenger/location demographic data associated with routes, time periods, past services, etc.), demand prediction data (e.g., user/passenger demand predictions for given routes/time periods, etc.), capacity data e.g., fleet capacity predictions for given routes/time periods, etc. given historical fleet data, existing service requests, etc.), user profile data, and/or the like for use in conjunction with the distribution service request data in determining timing and/or pricing for the requested autonomous robot distribution service. In some implementations, the operations computing system can also be configured to utilize this data to learn trends, demographics, and/or the like associated with routes, neighborhoods, users, passengers, and/or the like for use in improving vehicle selection, service timing (e.g., when requested services can be scheduled/provided), service pricing (e.g., estimated/actual costs for requested/completed services), etc.

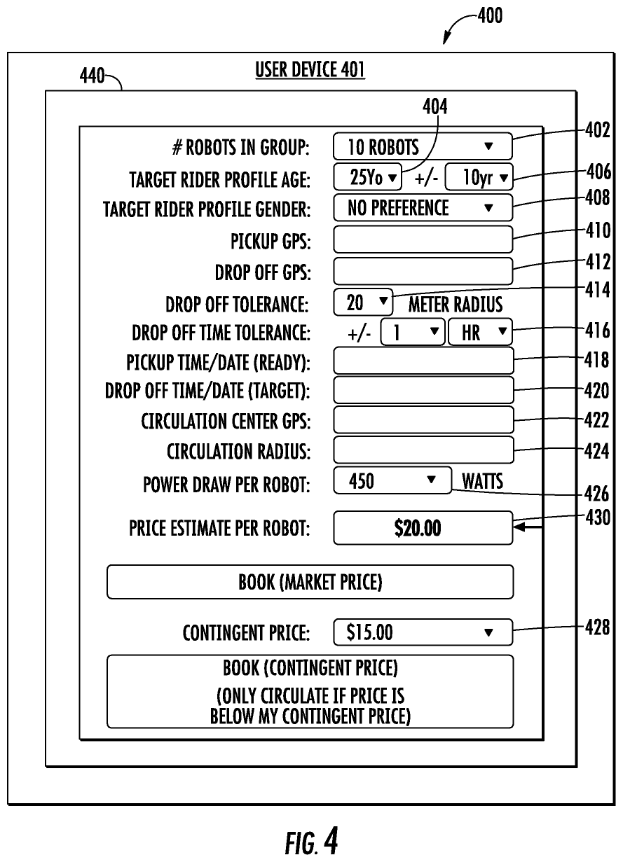

FIG. 4 depicts an example autonomous robot distribution request user interface 400 that can provide for requesting an autonomous robot distribution service that can include autonomous robot(s) marketing and/or dispensing items to vehicle passengers according to example embodiments of the present disclosure. In some implementations, an autonomous robot (e.g., autonomous robot 500, etc.) can be transported on an autonomous vehicle (e.g., autonomous vehicle 102, 600, etc.) throughout a service period (e.g., several hours, business day, full day, etc.) allowing the autonomous robot to market and/or dispense items carried by the autonomous robot to passengers who are onboard the autonomous vehicle (e.g., being provided with a transportation service by the autonomous vehicle) during the service period. For example, while onboard the autonomous vehicle, an autonomous robot may provide information to passengers in the autonomous vehicle cabin (e.g., via an interface onboard the autonomous robot, via an interface associated with the vehicle, via a user computing device application associated with the service entity, etc.) regarding one or more items available for purchase from the autonomous robot (e.g., onboard the autonomous robot in one or more compartments, etc.) and provide for dispensing purchased item(s) to passenger(s). One or more user interfaces can be provided (e.g., via a mobile application, website, etc.) to allow a user to request the use of an autonomous robot (e.g., autonomous robot 500, etc.) configured to market and/or dispense items and/or request the transport of an autonomous robot (e.g., autonomous robot 500, etc.) configured to market and/or dispense items. For example, in some implementations, a user device 401 (e.g., a personal computer, laptop, mobile phone, tablet, etc.) can present (e.g., via a display device 440) one or more user interfaces associated with the service entity.

As illustrated in FIG. 4, distribution request user interface 400 provides an example of a user interface allowing for user input of data associated with a distribution service request to transport an autonomous robot during a service period while the autonomous vehicle is providing transportation services to passengers. For example, distribution request user interface 400 can allow for input of data associated with a number of autonomous robots 402 included in the requested distribution service (e.g., one or more autonomous robots may be included in the requested distribution service and placed onboard a vehicle to market items to passengers). Distribution request user interface 400 can allow for input of data associated with a target rider profile age 404 and age range 406, for example, indicative of an age range for riders that may be provided with transportation services by an autonomous vehicle to which the user desires the autonomous robot to market one or more items carried onboard the autonomous robot. Distribution request user interface 400 can allow for input of data associated with a target rider profile gender 408, for example indicative of a gender preference, or no gender preference, for riders that may be provided with transportation services by an autonomous vehicle to which the user desires the autonomous robot to market one or more items carried onboard the autonomous robot. A user, passenger, and/or the like can be permitted a certain level of control over the types of information associated with the user that is stored and/or used by a service entity (e.g., demographic information, etc.). In some implementations, data/information associated with a user, passenger, and/or the like can be treated and/or processed using one or more techniques before it is stored and/or used. For example, one or more processing techniques can be utilized to remove certain demographic information, geographic information, and/or the like associated with the user. In some implementations, a user, passenger, and/or the like can elect whether (and/or when) a service entity can obtain and/or use such information.

Distribution request user interface 400 can allow for input of data associated with a pickup location 410 (e.g., a physical address, GPS coordinates, semantic place name, etc. indicative of a start location for the service, at the beginning of a service period) and a drop off location 412 (e.g., a physical address, GPS coordinates, etc. indicative of a destination location after the completion of a service period). Distribution request user interface 400 can allow for input of data associated with a drop off tolerance 414, which may be indicative of a distance range from the drop off location 412 that would be acceptable for the autonomous robot to be dropped off by an autonomous vehicle (e.g., an acceptable radius around the drop off location, etc.). Distribution request user interface 400 can allow for input of data associated with a pickup time/date 418 (e.g., a time/date when the autonomous robot will be available to be transported for the requested service) and a drop off time/date 420 (e.g., a target time/date when the user would like the autonomous robot to arrive at the service destination location). Distribution request user interface 400 can allow for input of data associated with a drop off time tolerance 416, which may be indicative of a time period around the requested drop off time/date 420 that would be acceptable to the user for the autonomous robot to be delivered to the location (e.g., a number of hours, minutes, days, etc. before/after the requested drop off time/date in which the autonomous robot can be delivered, etc.).

The user can provide data indicate of a circulation area in which the user would like the service entity to transport the autonomous robot(s) during a service period (e.g., number of hours, days, etc.). Distribution request user interface 400 can allow for input of data associated with a circulation center location 422 (e.g., indicative of a physical address, GPS coordinates, etc.), indicating a center point of an area in which the user desires the autonomous robot(s) to be transported by an autonomous vehicle to market one or more items carried onboard the autonomous robot(s) to passengers being provided transportation services by the autonomous vehicle. Distribution request user interface 400 can allow for input of data associated with a circulation radius 424 indicating the radius describing the area around circulation center location 422 in which the user desires the autonomous robot(s) to be transported by an autonomous vehicle to market and/or dispense one or more items carried onboard the autonomous robot(s) to passengers being provided transportation services by the autonomous vehicle. Alternatively or additionally, in some implementations, a user can provide data indicative of a geographical area (e.g., geo fence, neighborhood, street boundaries, etc.) that describes the area in which the user would like the autonomous robot(s) to travel to market and/or dispense items to passengers.

Distribution request user interface 400 can allow for input of data associated with a power draw 426 indicative of a power need required by the autonomous robot while onboard the autonomous vehicle (e.g., power to be supplied via one or more vehicle infrastructure systems/services, etc.)

Distribution request user interface 400 can allow for input of data associated with a contingent price 428, which may be indicative of a maximum cost that the user will accept for the requested service. The service entity (e.g., via an operations computing system, etc.) may determine a price estimate per autonomous robot 430 indicative of an estimated cost for providing the requested distribution service for each autonomous robot included in the service request. The estimated cost may be determined based at least in part on the distribution service request data input by the user (e.g., in distribution request user interface 400). The actual cost of a completed distribution service may be higher or lower than the price estimate 430. In some implementations, the service entity (e.g., via an operations computing system, etc.) can obtain historical service data (e.g., prior services data for routes/time periods, etc.), demographic data (e.g., user/passenger/location demographic data associated with routes, time periods, past services, etc.), demand prediction data (e.g., user/passenger demand predictions for given routes/time periods, etc.), capacity data (e.g., fleet capacity predictions for given routes/time periods, etc. given historical fleet data, existing service requests, etc.), user profile data, and/or the like for use in conjunction with the distribution service request data in determining timing and/or pricing for the requested autonomous robot distribution service. In some implementations, the operations computing system can also be configured to utilize this data to learn trends, demographics, and/or the like associated with routes, neighborhoods, users, passengers, and/or the like for use in improving vehicle selection, service timing, service pricing, etc.

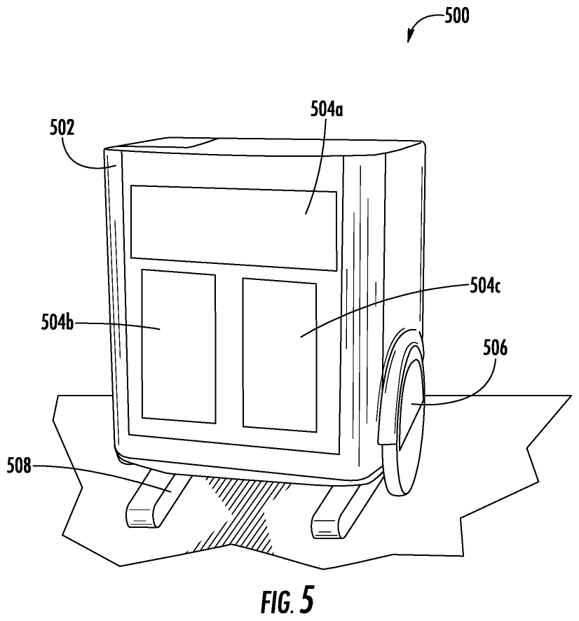

FIG. 5 depicts an example autonomous robot 500 according to example embodiments of the present disclosure. An autonomous robot can be configured to provide one or more services, such as transporting, marketing, and/or dispensing one or more items. For example, the autonomous robot 500 can include means for transporting one or more items. The item(s) to be transported by the autonomous robot 500 can include, for example, food, electronics, part supplies, tools, flowers, mail, reading materials, toys, medications, toiletries, other perishable items, other non-perishable items, and/or the like. The autonomous robot 500 can include a main body 502 which can include one or more compartments 504a-504c. Each of the compartments 504a-504c can be configured to provide support for transporting one or more item(s). The compartment(s) 504a-504c can be different sizes, shapes, etc. and/or can be configured to transport different items. For example, a first compartment 504a can be configured to transport food and a second compartment 504b can be configured to transport medicine. One or more of the compartment(s) 504a-504c can be physically separated from one another. In some implementations, the compartment(s) 504a-504c can be thermally separated from one another such that the compartment(s) 504a-504c can have different thermal conditions (e.g., temperature, humidity, etc.). In some implementations, the compartment(s) 504a-504c can include a lock (e.g., mechanical lock, magnetic lock, electronic lock, etc.). The lock can be adjusted between a locked state and an unlocked state to secure items while in transport and to allow for retrieval by an authorized user.

The autonomous robot 500 can also include means for allowing the autonomous robot 500 to move along a ground surface, into/off an autonomous vehicle, etc. For instance, the autonomous robot 500 can include a mobility assembly affixed to the main body 502. The mobility assembly can include, for example, at least one of two or more wheels 506 (e.g., a self-balancing wheel assembly, etc.), a track assembly 508 (e.g., one or more tracks, etc.), and/or other mechanism(s) for allowing the autonomous robot 500 to traverse a surface. The mobility assembly can be connected to a powertrain and/or other type of drive mechanism that is configured help start, maintain, reduce, etc. the motion of the mobility assembly (e.g., the wheels 506, track assembly 508, etc.). The autonomous robot 500 can also include means to allow the autonomous robot to travel autonomously to and from an autonomous vehicle (e.g., from a starting location, to a destination location) and to interface with one or more systems of an autonomous vehicle.

The autonomous robot 500 can be associated with one or more parties. For instance, in some implementations, the autonomous robot 500 can be associated with a service entity. As an example, the service entity can provide for a user (e.g., shipper, retailer, restaurant, consumer, etc.) to use, lease, rent, and/or the like the autonomous robot to transport items associated with the user. In some implementations, the autonomous robot 500 can be associated with a user (e.g., shipper, retailer, restaurant, consumer, etc.). The user can utilize the autonomous robot 500 to transport, market, and/or dispense items. In some implementations, the autonomous robot 500 can be associated with a third-party (e.g., not the service entity or user) which can provide (e.g., rent, lease, etc.) the autonomous robot 500 to be utilized by one or more users (e.g., shipper, retailer, restaurant, consumer, etc.).

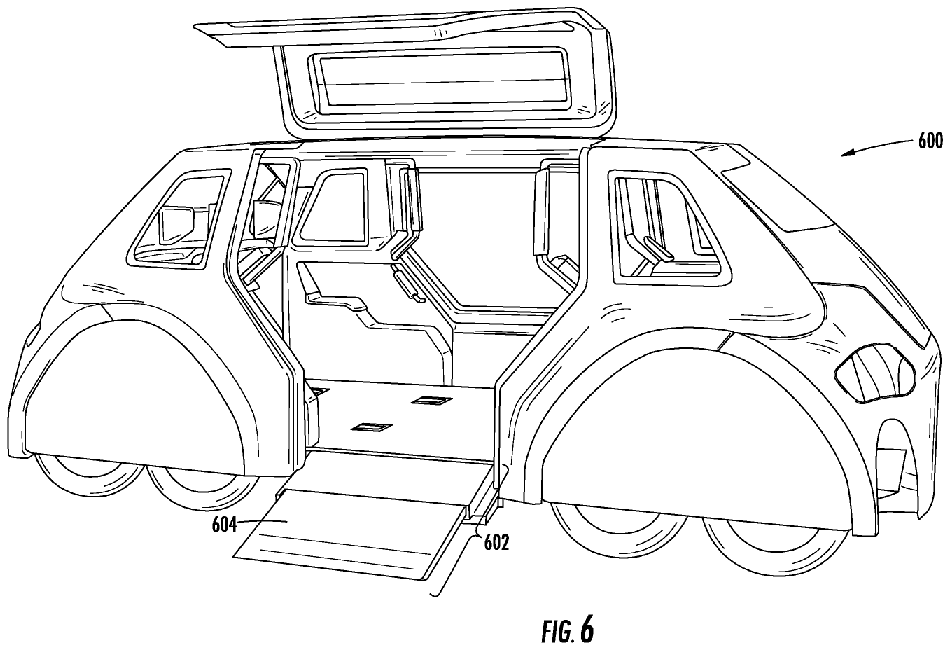

FIG. 6 depicts an example ground-based autonomous vehicle 600 according to example embodiments of the present disclosure. As illustrated in FIG. 6, an autonomous vehicle, such as described with regard to FIG. 1, can include a ground-based autonomous vehicle 600. The ground-based autonomous vehicle 600 can be configured to perform vehicle services for one or more service entities (e.g., service provider, vehicle provider, owner, manager, etc.). A ground-based autonomous vehicle 600 can perform a vehicle service by, for example, traveling (e.g., traveling autonomously) to a location associated with a requested vehicle service, allowing passenger(s), robot(s) and/or item(s) to board or otherwise enter the ground-based autonomous vehicle 600, transporting the passengers(s), robot(s), and/or item(s), allowing the passengers(s), robot(s), and/or item(s) to disembark or otherwise exit the ground-based autonomous vehicle 600, etc.

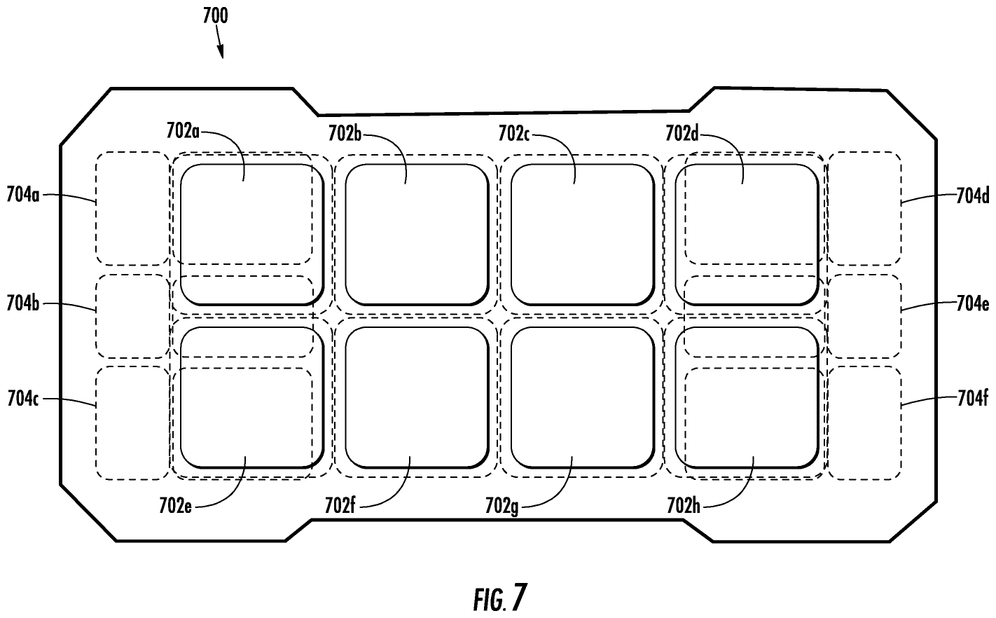

In some implementations, the ground-based autonomous vehicle 600 can be configured to transport one or more autonomous robots (e.g., autonomous robot 500 of FIG. 5) in addition to transporting one or more passengers within the vehicle cabin. For instance, the ground-based autonomous vehicle 600 can transport an autonomous robot 500 concurrently with one or more passengers to pool its transportation services and, thus, decrease a cost to a passenger/user. In some implementations, the ground-based autonomous vehicle 600 can be configured with one or more designated positions for an autonomous robot (e.g., autonomous robot 500, etc.) to be transported within the autonomous vehicle (as illustrated in FIG. 7), such that the autonomous robot can board the autonomous vehicle 600 and move to a designated position to be secured and interface with one or more of the autonomous vehicle systems.

In some implementations, an autonomous vehicle 600 can include a ramp 602. The ramp 602 can provide a pathway by which an autonomous robot (e.g., autonomous robot 500, etc.) and/or a passenger can enter and/or exit the autonomous vehicle 600 (e.g., an interior cabin). The ramp 602 can include an extendable tongue portion 604 (e.g., a telescoping tongue, etc.) that can extend away from and retract into the ramp 602. This can allow the ramp 602 to more easily accommodate various curbs, surfaces, heights, etc. when providing for an autonomous robot and/or passenger to board and/or disembark from the autonomous vehicle 600.

FIG. 7 depicts an example vehicle floor 700 within an autonomous vehicle according to example embodiments of the present disclosure. In some implementations, an autonomous vehicle (e.g., autonomous vehicle 600 of FIG. 6) can include one or more designated positions within the autonomous vehicle for an autonomous robot (e.g., autonomous robot 500 of FIG. 5). For example, as illustrated in FIG. 7, an autonomous vehicle (e.g., autonomous vehicle 600) can include a vehicle floor 700 which has a plurality of floor positions, such as positions 702a-702h. The positions 702a-702h can indicate designated positions within the vehicle cabin where an autonomous robot (e.g., autonomous robot 500, etc.) can be positioned for transport and/or to interface with one or more vehicle systems (e.g., power, communication, climate control, drainage, etc.). A position 702a-702h can include a designated area within a grid-like floor pattern as illustrated in FIG. 7. An autonomous robot (e.g., autonomous robot 500, etc.) can board the autonomous vehicle and move to one of the designated positions 702a-702h to be secured and/or interface with vehicle systems while onboard the autonomous vehicle.

In some implementations, the autonomous vehicle (e.g., autonomous vehicle 600) can also include one or more passenger seating positions, such as seating positions 704a-704f, which, when in use, may restrict the available positions 702a-702h that can be used by an autonomous robot (e.g., autonomous robot 500, etc.).

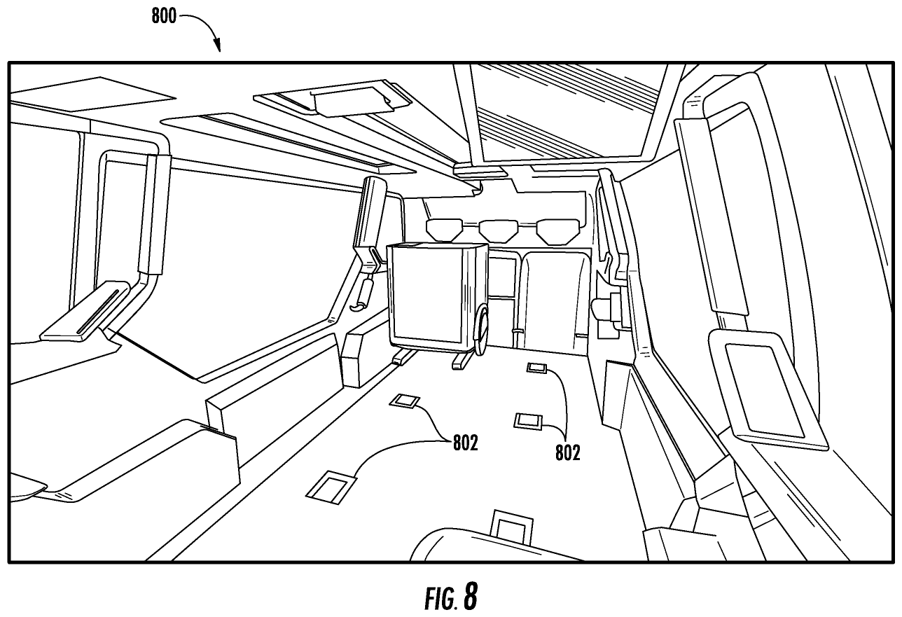

FIG. 8 depicts an example interior cabin 800 of an autonomous vehicle according to example embodiments of the present disclosure. In some implementations, the interior cabin 800 of an autonomous vehicle (e.g., the interior floor, walls, ceiling, etc. of autonomous vehicle 600) can include one or more cabin identifiers 802 (e.g., lights, reflective surfaces, markings, etc.) that indicate where an autonomous robot (e.g., autonomous robot 500, etc.) may position itself within the autonomous vehicle 600.

In some implementations, an autonomous robot (e.g., autonomous robot 500, etc.) can obtain sensor data indicative of these cabin identifiers 802, for example, when boarding the vehicle. The autonomous robot (e.g., the robot's onboard computing system) can determine a position within the autonomous vehicle (e.g., within the cabin 800) to which the autonomous robot should move based at least in part on the cabin identifiers 802 (e.g., via one or more sensors onboard the autonomous robot, etc.). The determined position can be, for example, a position 702a-702h within a grid-like floor pattern as shown in FIG. 7. Additionally, in some implementations, the autonomous robot can determine an available position for the autonomous robot based in part on one or more passengers and/or other autonomous robots already located within the cabin 800. Additionally or alternatively, in some implementations, the autonomous robot can determine an available position for the autonomous robot based in part on one or more signals from the autonomous vehicle. The autonomous robot (e.g., the robot's onboard computing system) can autonomously navigate to the determined position within the autonomous vehicle (e.g., a position that provides a passenger with sufficient space within the cabin 800) and the autonomous robot can be secured and/or interface with one or more vehicle systems at the determined position.

In some implementations, the interior cabin 800 of an autonomous vehicle can include one or more notification systems (e.g., visual indicators, audio indicators, etc.) to inform passengers located in the interior cabin 800 of one or more areas that should be kept clear while an autonomous robot (e.g., autonomous robot 500, etc.) is boarding and/or disembarking from the autonomous vehicle. For example, the floor of the interior cabin 800 may include one or more visual indicators (e.g., floor strip lighting, etc.) indicative of areas (e.g., an autonomous robot's designated position and a pathway to/from vehicle doorway from/to the designated position) where a passenger should refrain from placing an appendage (e.g., hands, feet, etc.), luggage, cargo, and or the like during autonomous robot movement about the interior cabin 800.

A service entity can use one or more autonomous vehicles, such as autonomous vehicle 600 illustrated in FIG. 6, to provide vehicle services, including autonomous robot transport services. For example, one or more autonomous vehicles (e.g., autonomous vehicle 600) in the service entity's fleet can be configured to transport autonomous robots (e.g., autonomous robot 500, etc.) concurrently with one or more passengers within the autonomous vehicle cabin. The autonomous robot transport services can include, for example, transporting one or more autonomous robots from a starting location to a destination location to provide for delivery of one or more items loaded onboard the autonomous robot (e.g., loaded by a user, etc. prior to the autonomous robot boarding an autonomous vehicle) to a recipient (e.g., at/near the destination location, etc.). The autonomous robot transport services can include, for example, one or more autonomous robots remaining onboard an autonomous vehicle during a service period to allow for marketing and/or dispensing one or more items loaded onboard the autonomous robot to one or more passengers being provided transportation services by the autonomous vehicle. The autonomous robot transport services can include, for example, the retrieval of one or more autonomous robots from a location where the service entity previously delivered the autonomous robot(s) (e.g., a destination location of a prior autonomous robot transport service).

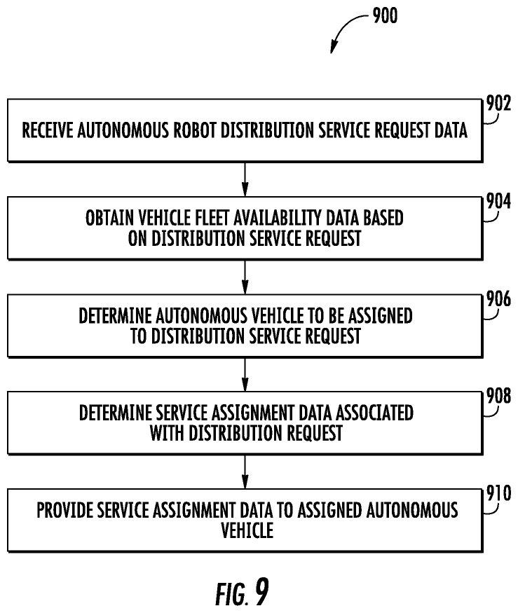

FIG. 9 depicts a flow diagram of example operations of a method 900 for autonomous robot distribution/delivery according to example embodiments of the present disclosure. One or more portion(s) of the method 900 can be implemented by one or more computing devices that include one or more computing devices such as, for example, the operations computing system 104 of FIG. 1, the vehicle computing system 112 of FIG. 1, the computing system 212 of FIG. 2, the remote computing system 220 of FIG. 2, and/or the like. Each respective portion of the method 900 can be performed by any (or any combination) of the one or more computing devices. Moreover, one or more portion(s) of the method 900 can be implemented as an algorithm on the hardware components of the device(s) described herein (e.g., as in FIGS. 1 and 2), for example, to provide for transport (e.g., distribution, delivery, retrieval, etc.) of an autonomous robot in association with an autonomous vehicle as described herein. FIG. 9 depicts elements performed in a particular order for purposes of illustration and discussion. Those of ordinary skill in the art, using the disclosures provided herein, will understand that the elements of any of the methods discussed herein can be adapted, rearranged, expanded, omitted, combined, and/or modified in various ways without deviating from the scope of the present disclosure. FIG. 9 is described with reference to elements/terms described with respect to other systems and figures for example illustrated purposes and is not meant to be limiting. One or more portions of method 900 can be performed additionally, or alternatively, by other systems.

At (902), the method 900 can include receiving data associated with an autonomous robot distribution service request. For example, a user (e.g., shipper, retailer, restaurant, supplier, etc.) can load one or more items onboard an autonomous robot (e.g., owned by the user, provided by the service entity, provided by a third party, etc.) that are to be transported to a delivery destination (e.g., recipient, etc.). The user can request a distribution service for the autonomous robot (e.g., autonomous robot 500, etc.) from a service entity. For example, in some implementations, a user device (e.g., a personal computer, laptop, mobile phone, tablet, etc.) can present (e.g., via a display device) one or more user interfaces associated with the service entity (e.g., as illustrated in FIGS. 3 and 4). The user can provide user input via the one or more interfaces to request the autonomous robot distribution service from the service entity. The distribution service request data can include, for example, a pickup location and destination location for an autonomous robot; a pickup time period and drop off time period for the autonomous robot; routing preferences for the autonomous robot (e.g., preferred route demographics for autonomous robots marketing/dispensing goods to vehicle passengers, etc.); the number of autonomous robots in a shipment group; requested vehicle infrastructure services (e.g., power requirements, communication requirements, temperature/humidity requirements, drainage requirements, etc.); identification data associated with an autonomous robot; and/or the like.

The service entity can use one or more autonomous vehicles (e.g., autonomous vehicle 102, 600, etc.) to provide vehicle services, including autonomous robot distribution services. For example, one or more autonomous vehicles in the service entity's fleet can be configured to transport autonomous robot(s) concurrently with one or more passengers. The autonomous vehicle(s) can be configured with one or more designated positions for an autonomous robot to be transported within the autonomous vehicle, such that the autonomous robot can board the autonomous vehicle and move to a designated position to be secured and interface with one or more of the autonomous vehicle systems. A computing system associated with the service entity (e.g., operations computing system) can obtain the data associated with a request for an autonomous robot transport service (e.g., autonomous robot distribution service request).

At (904), the method 900 can include obtaining vehicle fleet availability data based at least in part on the request for the autonomous robot transport service (e.g., autonomous robot distribution service request data). For example, a computing system associated with the service entity (e.g., operations computing system 104, etc.) can be configured to coordinate the autonomous robot distribution service request based at least in part on the data provided by the user and data associated with the service entity's vehicle fleet. For instance, the operations computing system can obtain data associated with the autonomous vehicle(s) in the service entity vehicle fleet (e.g., vehicle location, demand, availability, capacity, routing, etc.) based in part on the distribution service request data and use such vehicle fleet availability data to identify one or more autonomous vehicles that would be available to provide the requested services.

At (906), the method 900 can include determining an autonomous vehicle to be assigned to the autonomous robot distribution service request. For example, the service entity (e.g., operations computing system 104, etc.) can select an autonomous vehicle (e.g., autonomous vehicle 102, 600, etc.) to assign for provision of the requested autonomous robot distribution service from one or more available vehicles in the service entity's fleet based at least in part on vehicle fleet availability data and the distribution service request data.

At (908), the method 900 can include determining service assignment data associated with the autonomous robot distribution service request for the selected autonomous vehicle. For example, the service entity (e.g., operations computing system 104, etc.) can generate data associated with the requested autonomous robot distribution service that can facilitate the assigned autonomous vehicle (e.g., autonomous vehicle 102, 600, etc.) providing the requested distribution service (e.g., service assignment, etc.). The service assignment data can be generated based at least in part on the distribution service request data and the selected autonomous vehicle. The data associated with the requested autonomous robot service (e.g., service assignment, etc.) can indicate, for example, a pickup location for the autonomous robot; a destination location for the autonomous robot; a time period for the service (e.g., pickup time range, drop off time range, etc.); route data for the autonomous robot service; identification data associated with the autonomous robot (e.g., RFID, etc. that can be utilized to identify); requested vehicle infrastructure services for the autonomous robot; a user associated with the distribution service request; and/or the like.

At (910), the method 900 can include providing the service assignment data to the selected autonomous vehicle. For example, the service entity (e.g., operations computing system, etc.) can provide the service assignment data to the assigned autonomous vehicle (e.g., autonomous vehicle 102, 600, etc.), such that the autonomous vehicle can provide the requested distribution service. For instance, the autonomous vehicle can initiate travel, based on the service assignment data, to a service starting location at which the autonomous robot (e.g., autonomous robot 500, etc.) can board the autonomous vehicle for provision of the requested distribution service.

In some implementations, the service entity (e.g., operations computing system 104, autonomous vehicle computing system 112, etc.) can communicate with the autonomous robot (e.g., autonomous robot 500, etc.) to provide data associated with the distribution service to the autonomous robot. For example, the autonomous robot can be provided with data associated with the service route and/or service timing such that the autonomous robot can travel to an appropriate location/position to efficiently board the autonomous vehicle. Additionally, or alternatively, the autonomous robot can be provided with data associated with the autonomous vehicle such as, for example, an identifier that can allow the autonomous robot to identify the autonomous vehicle (e.g., to help ensure that the robot locates and boards the correct autonomous vehicle).

In some implementations, the autonomous robot (e.g., autonomous robot 500, etc.) can move to the pickup location, identify the assigned autonomous vehicle (e.g., autonomous vehicle 102, 600, etc.) at the pickup location (e.g., via sensor data analysis, robot to vehicle communication, etc.), and board the autonomous vehicle (e.g., using autonomy system(s) onboard the autonomous robot, etc.). The autonomous robot may move to a designated location in the cabin of the autonomous vehicle where it can be secured and/or interface with one or more infrastructure systems/services onboard the vehicle. The autonomous vehicle may then continue along an assigned route and, for example, make stops to allow one or more passengers to board or disembark from the autonomous vehicle. Upon reaching the delivery destination for the autonomous robot distribution service, the autonomous robot may disengage from any vehicle infrastructure systems/services, disembark from the autonomous vehicle, and travel to a delivery location/position (e.g., using autonomy system(s) onboard the robot, etc.).

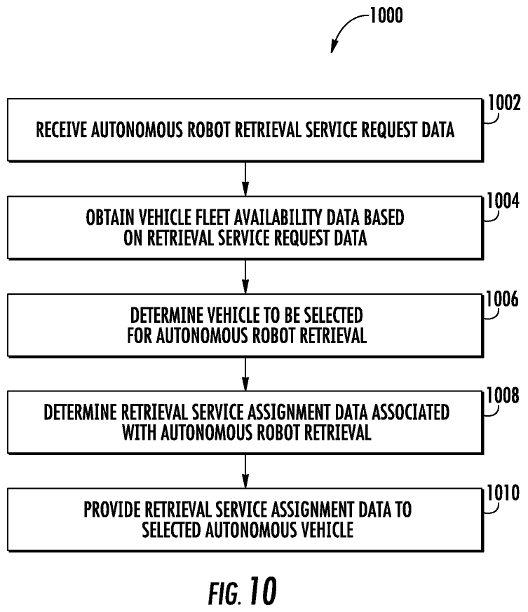

FIG. 10 depicts a flow diagram of example operations of a method 1000 for autonomous robot retrieval according to example embodiments of the present disclosure. One or more portion(s) of the method 1000 can be implemented by one or more computing devices that include one or more computing devices such as, for example, those of the operations computing system 104 of FIG. 1, the vehicle computing system 112 of FIG. 1, the computing system 212 of FIG. 2, the remote computing system 220 of FIG. 2, and/or the like. Each respective portion of the method 1000 can be performed by any (or any combination) of the one or more computing devices. Moreover, one or more portion(s) of the method 1000 can be implemented as an algorithm on the hardware components of the device(s) described herein (e.g., as in FIGS. 1 and 2), for example, to provide for transportation (e.g., distribution, delivery, retrieval, etc.) of an autonomous robot in association with an autonomous vehicle as described herein. FIG. 10 depicts elements performed in a particular order for purposes of illustration and discussion. Those of ordinary skill in the art, using the disclosures provided herein, will understand that the elements of any of the methods discussed herein can be adapted, rearranged, expanded, omitted, combined, and/or modified in various ways without deviating from the scope of the present disclosure. FIG. 10 is described with reference to elements/terms described with respect to other systems and figures for example illustrated purposes and is not meant to be limiting. One or more portions of method 1000 can be performed additionally, or alternatively, by other systems.

In some implementations, a service entity can provide for retrieving an autonomous robot (e.g., autonomous robot 500, etc.) from a delivery location (e.g., from a delivery recipient once onboard items have been unloaded, etc.) and returning the autonomous robot to a user, third party, and/or service entity location (e.g., storage facility, distribution facility, etc.). At (1002), the method 1000 can include receiving data associated with an autonomous robot transport service such as, for example, an autonomous robot retrieval service request. For example, the service entity (e.g., operations computing system 104, etc.) can receive data indicating that a previously delivered autonomous robot (e.g., autonomous robot 500, etc.) is ready for retrieval from a prior delivery location. The retrieval service request data can be generated, for example, by the autonomous robot, by a delivery recipient, by the user/third party associated with the autonomous robot, and/or the like. The retrieval service request data can include, for example, identification data for the autonomous robot; a pickup location for the autonomous robot; a destination location for the autonomous robot; a pickup time period for the autonomous robot; a drop off time period for the autonomous robot; requested vehicle infrastructure services (e.g., power requirements, communication requirements, temperature/humidity requirements, drainage requirements, etc.); and/or the like. In some implementations, the retrieval service request data can be provided by the user, third party, delivery recipient, and/or the like using one or more user interfaces associated with the service entity (e.g., via a service entity application, website, etc.). For example, the service entity may have previously provided an autonomous robot distribution service for a retailer (e.g., user). The retailer may have loaded item(s) onboard an autonomous robot and had the autonomous robot delivered near or to a recipient (e.g., purchaser of the item(s), etc.) location by the service entity. After the recipient has removed the item(s) from the delivered autonomous robot, the autonomous robot would need to be returned to the retailer (e.g., user). As such, an autonomous robot retrieval service request can be provided to the service entity (e.g., by the autonomous robot, user, recipient, etc.) to have the previously delivered autonomous robot retrieved from the purchaser's location (e.g., at/near the destination location of the prior distribution service), at another location to which the autonomous robot has traveled, etc.).

At (1004), the method 1000 can include obtaining vehicle fleet availability data based at least in part on the autonomous robot retrieval service request data. For example, a computing system associated with the service entity (e.g., operations computing system 104, etc.) can be configured to coordinate the autonomous robot retrieval service request based at least in part on the retrieval service request data and data associated with the service entity's vehicle fleet. For instance, the operations computing system can obtain data associated with the autonomous vehicle(s) in the service entity vehicle fleet (e.g., vehicle location, availability, demand, capacity, routing, etc.) based in part on the retrieval service request data and use such vehicle fleet availability data to identify one or more autonomous vehicles that would be available to provide the requested retrieval services.

At (1006), the method 1000 can include determining an autonomous vehicle to be selected for the autonomous robot retrieval service request. For example, the service entity (e.g., operations computing system 104, etc.) can select an autonomous vehicle (e.g., autonomous vehicle 102, 600, etc.) to assign for provision of the requested autonomous robot retrieval service from one or more available vehicles in the service entity's fleet based at least in part on vehicle fleet availability data; the retrieval service request data; and/or data associated with the autonomous robot to be retrieved (e.g., current location, etc.).

At (1008), the method 1000 can include determining retrieval service assignment data associated with the autonomous robot retrieval service for the selected autonomous vehicle. For example, the service entity (e.g., operations computing system 104, etc.) can generate data associated with the requested autonomous robot retrieval service that can facilitate the assigned autonomous vehicle (e.g., autonomous vehicle 102, 600, etc.) providing the requested retrieval service (e.g., service assignment, etc.). The service assignment data can be generated based at least in part on the retrieval service request data and the selected autonomous vehicle. The data associated with the requested autonomous robot retrieval service (e.g., service assignment, etc.) can indicate, for example, identification data associated with the autonomous robot; a pickup location for the autonomous robot; a destination location for the autonomous robot; a time period for the service; requested vehicle infrastructure services for the autonomous robot; a user associated with the retrieval service request; and/or the like.

At (1010), the method 1000 can include providing the retrieval service assignment data to the selected autonomous vehicle. For example, the service entity (e.g., operations computing system, etc.) can provide the service assignment data to the assigned autonomous vehicle (e.g., autonomous vehicle 102, 600, etc.), such that the autonomous vehicle can provide the requested retrieval service. For instance, the autonomous vehicle can initiate travel, based on the service assignment data, to a retrieval service starting location at which the autonomous robot (e.g., autonomous robot 500, etc.) can board the autonomous vehicle for provision of the requested retrieval service.

In some implementations, the service entity (e.g., operations computing system 104, autonomous vehicle computing system 112, etc.) can communicate with the autonomous robot (e.g., autonomous robot 500, etc.) to provide data associated with the retrieval service to the autonomous robot. For example, the autonomous robot can be provided with data associated with the service route and/or service timing such that the autonomous robot can travel to an appropriate location/position to efficiently board the autonomous vehicle. Additionally, or alternatively, the autonomous robot can be provided with data associated with the autonomous vehicle such as, for example, an identifier that can allow the autonomous robot to identify the autonomous vehicle (e.g., to help ensure that the robot locates and boards the correct autonomous vehicle).

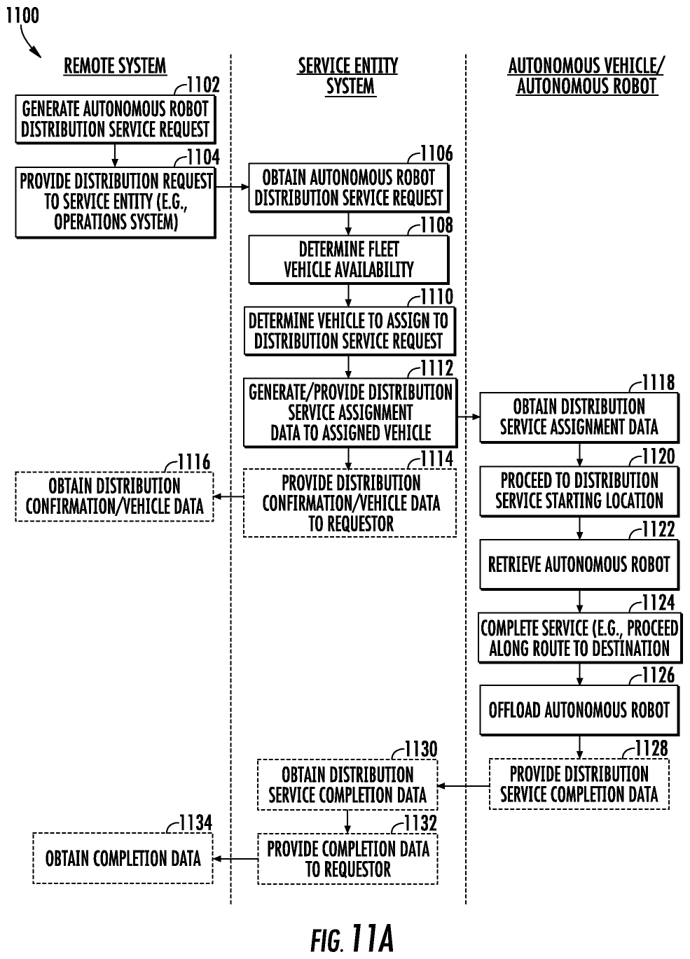

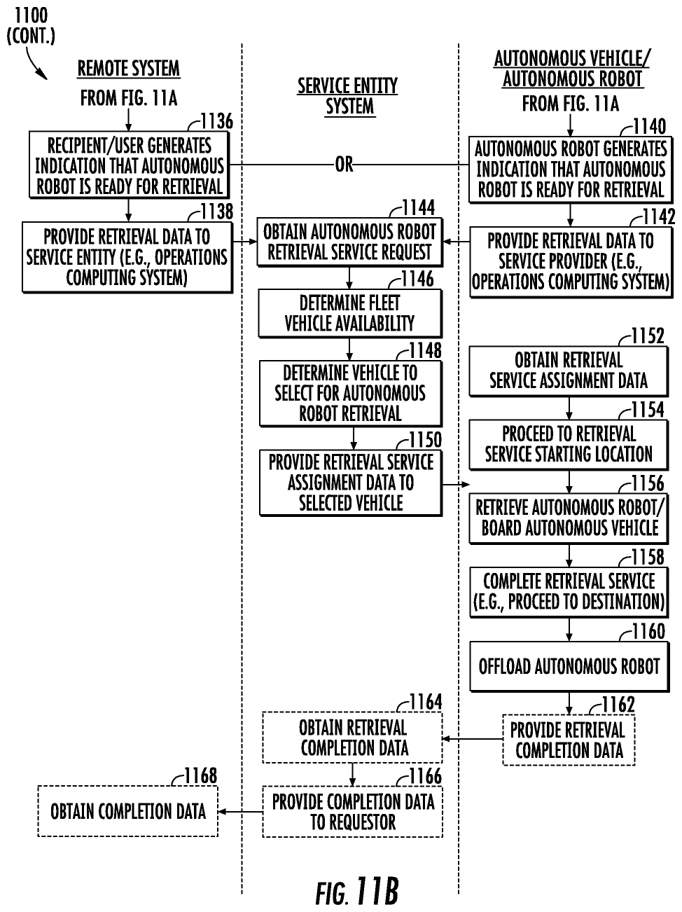

FIGS. 11A-11B depict flow diagrams of example operations of a method 1100 of an autonomous robot distribution system according to example embodiments of the present disclosure. One or more portion(s) of the method 1100 can be implemented by one or more computing devices that include one or more computing devices such as, for example, the operations computing system 104 of FIG. 1, the vehicle computing system 112 of FIG. 1, the computing system 212 of FIG. 2, the remote computing system 220 of FIG. 2, and/or the like. Each respective portion of the method 1100 can be performed by any (or any combination) of the one or more computing devices. Moreover, one or more portion(s) of the method 1100 can be implemented as an algorithm on the hardware components of the device(s) described herein (e.g., as in FIGS. 1 and 2), for example, to provide for transportation (e.g., distribution, delivery, retrieval, etc.) of an autonomous robot in association with an autonomous vehicle as described herein. FIGS. 11A-B depict elements performed in a particular order for purposes of illustration and discussion. Those of ordinary skill in the art, using the disclosures provided herein, will understand that the elements of any of the methods discussed herein can be adapted, rearranged, expanded, omitted, combined, and/or modified in various ways without deviating from the scope of the present disclosure. FIGS. 11A-B are described with reference to elements/terms described with respect to other systems and figures for example illustrated purposes and is not meant to be limiting. One or more portions of method 1100 can be performed additionally, or alternatively, by other systems.

At (1102), the method 1100 can include generating an autonomous robot distribution service request at a remote computing system, for example, associated with a user (e.g., shipper, retailer, restaurant, supplier, consumer, etc.). For example, a user (e.g., shipper, retailer, restaurant, supplier, etc.) can load one or more items onboard an autonomous robot (e.g., owned by the user, provided by the service entity, provided by a third party, etc.) that are to be transported to a delivery destination (e.g., recipient, etc.). The user can request a distribution service for the autonomous robot (e.g., autonomous robot 500, etc.) from a service entity. For example, in some implementations, a user device (e.g., a personal computer, laptop, mobile phone, tablet, etc.) can present (e.g., via a display device) one or more user interfaces associated with the service entity (e.g., as illustrated in FIGS. 3 and 4). The user can provide user input via the one or more interfaces to request the autonomous robot distribution service from the service entity. The distribution service request data can include, for example, a pickup location and destination location for an autonomous robot; a pickup time period and drop off time period for the autonomous robot; routing preferences for the autonomous robot (e.g., preferred route demographics for autonomous robots marketing/dispensing goods to vehicle passengers, etc.); the number of autonomous robots in a shipment group; requested vehicle infrastructure services (e.g., power requirements, communication requirements, temperature/humidity requirements, drainage requirements, etc.); identification data associated with an autonomous robot; and/or the like. At (1104), the method 1100 can include the remote computing system providing the autonomous robot distribution request to a service entity.

At (1106), the method 1100 can include obtaining the autonomous robot distribution service request by a service entity (e.g., operations computing system, etc.). The service entity can use one or more autonomous vehicles (e.g., autonomous vehicle 102, 600, etc.) to provide vehicle services, including autonomous robot distribution and/or retrieval services. For example, one or more autonomous vehicles in the service entity's fleet can be configured to transport autonomous robot(s) concurrently with one or more passengers. The autonomous vehicle(s) can be configured with one or more designated positions for an autonomous robot to be transported within the autonomous vehicle, such that the autonomous robot can board the autonomous vehicle and move to a designated position to be secured and interface with one or more of the autonomous vehicle systems.

At (1108), the method 1100 can include obtaining and/or determining, by the service entity (e.g., via an operations computing system, etc.), service entity vehicle fleet availability based at least in part on the autonomous robot distribution service request. For example, the service entity (e.g., operations computing system 104, etc.) can coordinate the autonomous robot distribution service request based at least in part on the data provided by the user and data associated with the service entity's vehicle fleet. For instance, the operations computing system can obtain data associated with the autonomous vehicle(s) in the service entity vehicle fleet (e.g., vehicle location, availability, demand, capacity, routing, etc.) based in part on the distribution service request data and use such vehicle fleet availability data to identify one or more autonomous vehicles that would be available to provide the requested services.

At (1110), the method 1100 can include determining, by the service entity, an autonomous vehicle to be assigned for the autonomous robot distribution service request based at least in part on the vehicle fleet availability and the autonomous robot distribution service request. For example, the service entity (e.g., operations computing system 104, etc.) can select an autonomous vehicle (e.g., autonomous vehicle 102, 600, etc.) to assign for provision of the requested autonomous robot distribution service from one or more available vehicles in the service entity's fleet based at least in part on vehicle fleet availability data and the distribution service request.

At (1112), the method 1100 can include generating, by the service entity, service assignment data associated with the autonomous robot distribution service request for the selected autonomous vehicle and providing the service assignment data to the selected autonomous vehicle. For example, the service entity (e.g., operations computing system 104, etc.) can generate data associated with the requested autonomous robot distribution service that can facilitate the assigned autonomous vehicle (e.g., autonomous vehicle 102, 600, etc.) providing the requested distribution service (e.g., service assignment, etc.). The service assignment data can be generated based at least in part on the distribution service request data and the selected autonomous vehicle. The data associated with the requested autonomous robot service (e.g., service assignment, etc.) can indicate, for example, a pickup location for the autonomous robot; a destination location for the autonomous robot; a time period for the service (e.g., pickup time range, drop off time range, etc.); route data for the autonomous robot service; identification data associated with the autonomous robot; requested vehicle infrastructure services for the autonomous robot; a user associated with the distribution service request; and/or the like.

The service entity (e.g., operations computing system, etc.) can provide the service assignment data to the assigned autonomous vehicle (e.g., autonomous vehicle 102, 600, etc.), such that the autonomous vehicle can provide the requested distribution service. For instance, the autonomous vehicle can initiate travel, based on the service assignment data, to a service starting location at which the autonomous robot (e.g., autonomous robot 500, etc.) can board the autonomous vehicle for provision of the requested distribution service.

In some implementations, the service entity (e.g., operations computing system 104, autonomous vehicle computing system 112, etc.) can communicate with the autonomous robot (e.g., autonomous robot 500, etc.) to provide data associated with the distribution service to the autonomous robot. For example, the autonomous robot can be provided with data associated with the service route and/or service timing such that the autonomous robot can travel to an appropriate location/position to efficiently board the autonomous vehicle. Additionally, or alternatively, the autonomous robot can be provided with data associated with the autonomous vehicle such as, for example, an identifier that can allow the autonomous robot to identify the autonomous vehicle (e.g., to help ensure that the robot locates and boards the correct autonomous vehicle).

Optionally, at (1114), the method 1100 can include providing a service assignment confirmation and/or assigned vehicle data to the user who requested the autonomous robot distribution service. For example, once an autonomous vehicle has been assigned to provide the service and service assignment data has been generated, the service entity (e.g., operations computing system 104, etc.) may provide service assignment confirmation data to the user. The service assignment confirmation data may comprise information such as, for example, identification data associated with the assigned autonomous vehicle; expected timing for the service; confirmation of data provided in the distribution service request; cost for the distribution service; and/or the like. Optionally, at (1116), the method 1100 can include receiving the assignment confirmation and/or assigned vehicle data at a remote computing system associated with the user.

At (1118), the method 1100 can include obtaining the service assignment data by the selected autonomous vehicle. At (1120), the method 1100 can include the selected autonomous vehicle initiating travel to the service starting location associated with the autonomous robot distribution request. For example, upon receiving the service assignment data, the autonomous vehicle can travel to a service starting location indicated by the service assignment data, at which the autonomous vehicle can facilitate one or more operations to provide for the autonomous robot boarding the autonomous vehicle.

At (1122), the method 1100 can include retrieving the autonomous robot associated with the autonomous robot distribution request (e.g., providing for the autonomous robot to board the vehicle). For example, in some implementations, the autonomous robot (e.g., autonomous robot 500, etc.) can move to a pickup location, identify the assigned autonomous vehicle (e.g., autonomous vehicle 102, 600, etc.) at the pickup location (e.g., via sensor data analysis, robot to vehicle communication, etc.), and board the autonomous vehicle (e.g., using autonomy system(s) onboard the autonomous robot, etc.). For example, an autonomous vehicle (e.g., autonomous vehicle 600, etc.) can include a ramp that can provide a pathway by which the autonomous robot (and/or a passenger, etc.) can enter and/or exit the autonomous vehicle (e.g., an interior cabin). The autonomous robot can board the autonomous vehicle by controlling a mobility assembly (e.g., one or more self-balancing wheels, one or more track assemblies, etc.) to traverse a ramp, stairs, and/or other entry way into the interior cabin of the autonomous vehicle. The autonomous robot may move to a designated location in the cabin of the autonomous vehicle where it can be secured and/or interface with one or more infrastructure systems/services onboard the vehicle.

At (1124), the method 1100 can include the selected autonomous vehicle commencing travel to the service destination location. For example, after the autonomous robot (e.g., autonomous robot 500, etc.) has been secured in a designated position onboard the autonomous vehicle, the autonomous vehicle may proceed to travel along an assigned route. In some implementations, the autonomous vehicle may stop at one or more locations along the assigned route, for example, to allow for passenger(s) to board or disembark from the autonomous vehicle.

Additionally, in some implementations, while onboard the autonomous vehicle, the autonomous robot may provide information to passenger(s) in the autonomous vehicle cabin (e.g., via an interface onboard the autonomous robot, via an interface associated with the vehicle, via a user computing device application associated with the service entity, etc.) regarding one or more items available for purchase from the autonomous robot (e.g., onboard the autonomous robot in one or more compartments, etc.) and provide for dispensing purchased item(s) to passenger(s). In some implementations, a service entity may select an autonomous vehicle to be assigned for a requested service from a passenger (rideshare service, etc.) based on whether a vehicle is transporting an autonomous robot having purchasable items onboard. For example, based in part on data associated with the requesting user, a service entity may select from multiple autonomous vehicles nearby the service starting location by determining whether one of the vehicles is transporting an autonomous robot that is carrying item(s) that the passenger may wish to purchase.

In some implementations, one or more autonomous robots can be loaded onto an autonomous vehicle before the autonomous vehicle is made available to riders, passengers, and/or the like for transportation services (e.g., rideshare services, etc.). In some implementations, the autonomous vehicle can proceed to the rider/passenger destination and allow the rider(s)/passenger(s) to disembark before proceeding to the delivery destination for the autonomous robot(s). In some implementations, the autonomous robot(s) can remain on the autonomous vehicle throughout the service period (e.g., several hours, business day, full day, etc.) allowing the autonomous robot(s) to market and/or dispense items carried by the autonomous robot(s) to riders, passengers, and/or the like who board the autonomous vehicle throughout the service period.

At (1126), the method 1100 can include offloading the autonomous robot associated with the autonomous robot distribution request from the autonomous vehicle. For example, upon reaching a destination location for the autonomous robot service (e.g., delivery location, etc.), the autonomous robot (e.g., autonomous robot 500, etc.) can disengage from any vehicle infrastructure systems/services and disembark from the autonomous vehicle (e.g., using autonomy system(s) onboard the robot, etc.). The autonomous robot travel to an appropriate delivery location/position (e.g., using autonomy system(s) onboard the robot, etc.) at the destination (e.g., the recipient's location/position, etc.).

Optionally, at (1128), the method 1100 can include providing distribution service completion data to the service entity. For example, once the autonomous robot has disembarked from the autonomous vehicle, the autonomous vehicle and/or the autonomous robot may provide data indicative of the arrival of the autonomous robot at the destination location to the service entity (e.g., operations computing system 104, etc.). Optionally, at (1130), the method 1100 can include obtaining distribution service completion data by the service entity, for example, from the autonomous vehicle and/or the autonomous robot. Optionally, at (1132), the method 1100 can include providing distribution service completion data to the user. Optionally, at (1134), the method 1100 can include obtaining distribution service completion data by the user. For example, the service entity (e.g., operations computing system 104, etc.) may provide the autonomous robot distribution service completion data to the user who requested the autonomous robot transport service (e.g., via a user computing device, etc.). The service completion data may include, for example, an identifier associated with the autonomous robot; a location where the autonomous robot disembarked; a time at which the autonomous robot disembarked; and/or the like.

Subsequent to an autonomous robot (e.g., autonomous robot 500, etc.) being transported to a destination by an autonomous vehicle associated with the service entity, the service entity can receive a request to retrieve the previously delivered autonomous robot, for example, from the autonomous robot, from the recipient, from the user/third party associated with the autonomous robot, etc., and transport the autonomous robot to a user, third party, and/or service entity location (e.g., storage facility, distribution facility, etc.). FIG. 11B illustrates example operations for the autonomous robot retrieval subsequent to the autonomous robot delivery depicted in FIG. 11A. As provided in FIG. 11B, the request for the autonomous robot retrieval may originate from a remote computing system (e.g., associated with a user, third-party, recipient, etc.) at (1136) or the request for the autonomous robot retrieval may originate from the autonomous robot itself at (1140).

At (1136), the method 1100 can include generating an autonomous robot retrieval service request at a remote computing system, for example, associated with the user, third-party, delivery recipient, and/or the like. For example, when a previously delivered autonomous robot (e.g., autonomous robot 500, etc.) is ready for retrieval, a retrieval service request can be generated by a delivery recipient, by the user/third party associated with the autonomous robot, and/or the like. The retrieval service request data can include, for example, identification data for the autonomous robot to be retrieved; a pickup location for the autonomous robot; a destination location for the autonomous robot; a pickup time period for the autonomous robot; a drop off time period for the autonomous robot; requested vehicle infrastructure services (e.g., power requirements, communication requirements, temperature/humidity requirements, drainage requirements, etc.); and/or the like. In some implementations, the retrieval service request data can be provided by the user, third party, delivery recipient, and/or the like using one or more user interfaces associated with the service entity (e.g., via a service entity application, website, etc.). At (1138), the method 1100 can include the remote computing system providing the autonomous robot retrieval service request to a service entity (e.g., operations computing system, etc.).

Alternatively, at (1140), the method 1100 can include an autonomous robot generating a retrieval service request. For example, when a previously delivered autonomous robot (e.g., autonomous robot 500, etc.) is ready for retrieval, a retrieval service request can be generated by the autonomous robot. The retrieval service request data can include, for example, identification data for the autonomous robot; a pickup location for the autonomous robot; a destination location for the autonomous robot; a pickup time period for the autonomous robot; a drop off time period for the autonomous robot; requested vehicle infrastructure services (e.g., power requirements, communication requirements, temperature/humidity requirements, drainage requirements, etc.); and/or the like. At (1142), the method 1100 can include the autonomous robot providing the retrieval service request to a service entity (e.g., operations computing system, etc.).

At (1144), the method 1100 can include obtaining the autonomous robot retrieval service request by a service entity (e.g., operations computing system).

At (1146), the method 1100 can include obtaining and/or determining, by the service entity (e.g., operations computing system, etc.), service entity vehicle fleet availability based at least in part on the autonomous robot retrieval service request. For example, the service entity (e.g., operations computing system 104, etc.) can coordinate the autonomous robot retrieval service request based at least in part on the retrieval service request data and data associated with the service entity's vehicle fleet. For instance, the operations computing system can obtain data associated with the autonomous vehicle(s) in the service entity vehicle fleet (e.g., vehicle location, availability, demand, capacity, routing, etc.) based at least in part on the retrieval service request data and use such vehicle fleet availability data to identify one or more autonomous vehicles that would be available to provide the requested retrieval services.

At (1148), the method 1100 can include determining, by the service entity, an autonomous vehicle to be assigned for the autonomous robot retrieval service request based at least in part on the vehicle fleet availability and the retrieval service request. For example, the service entity (e.g., operations computing system 104, etc.) can select an autonomous vehicle (e.g., autonomous vehicle 102, 600, etc.) to assign for provision of the requested autonomous robot retrieval service from one or more available vehicles in the service entity's fleet based at least in part on vehicle fleet availability data; the retrieval service request data; and/or data associated with the autonomous robot to be retrieved (e.g., current location, etc.).

At (1150), the method 1100 can include generating, by the service entity, service assignment data associated with the autonomous robot retrieval service request for the selected autonomous vehicle and providing the service assignment data to the selected autonomous vehicle. For example, the service entity (e.g., operations computing system 104, etc.) can generate data associated with the requested autonomous robot retrieval service that can facilitate the assigned autonomous vehicle (e.g., autonomous vehicle 102, 600, etc.) providing the requested retrieval service (e.g., service assignment, etc.). The service assignment data can be generated based at least in part on the retrieval service request and the selected autonomous vehicle. The data associated with the requested autonomous robot retrieval service (e.g., service assignment, etc.) can include, for example, identification data associated with the autonomous robot; a pickup location for the autonomous robot; a destination location for the autonomous robot; a time period for the service; requested vehicle infrastructure services for the autonomous robot; a user associated with the retrieval service request; and/or the like.

The service entity (e.g., operations computing system, etc.) can provide the service assignment data to the assigned autonomous vehicle (e.g., autonomous vehicle 102, 600, etc.), such that the autonomous vehicle can provide the requested retrieval service. For instance, the autonomous vehicle can initiate travel, based on the service assignment data, to a retrieval service starting location at which the autonomous robot (e.g., autonomous robot 500, etc.) can board the autonomous vehicle for provision of the requested retrieval service.

At (1152), the method 1100 can include the selected autonomous vehicle obtaining the service assignment data. At (1154), the method 1100 can include the selected autonomous vehicle initiating travel to the retrieval service starting location associated with the autonomous robot retrieval request. For example, upon receiving the service assignment data, the autonomous vehicle can travel to a retrieval service starting location indicated by the service assignment data, at which the autonomous vehicle can facilitate one or more operations to provide for the autonomous robot boarding the autonomous vehicle.

At (1156), the method 1100 can include retrieving the autonomous robot associated with the retrieval service request (e.g., providing for the autonomous robot to board the autonomous vehicle). For example, in some implementations, the autonomous robot (e.g., autonomous robot 500, etc.) can move to a pickup location, identify the assigned autonomous vehicle (e.g., autonomous vehicle 102, 600, etc.) at the pickup location (e.g., via sensor data analysis, robot to vehicle communication, etc.), and board the autonomous vehicle (e.g., using autonomy system(s) onboard the autonomous robot, etc.). The autonomous robot may move to a designated location in the cabin of the autonomous vehicle where it can be secured and/or interface with one or more infrastructure systems/services onboard the vehicle.

At (1158), the method 1100 can include the autonomous vehicle completing the retrieval service (e.g., traveling to the retrieval service destination). For example, after the autonomous robot (e.g., autonomous robot 500, etc.) has been secured in a designated position onboard the autonomous vehicle, the autonomous vehicle may proceed to travel to a user, third party, and/or service entity location (e.g., storage facility, etc.) associated with the retrieval service request.

At (1160), the method 1100 can include offloading the autonomous robot from the autonomous vehicle at the retrieval destination. For example, upon reaching a retrieval destination location for the autonomous robot service (e.g., user, third party, and/or service entity storage facility, distribution facility, etc.), the autonomous robot (e.g., autonomous robot 500, etc.) can disengage from any vehicle infrastructure systems/services and disembark from the autonomous vehicle (e.g., using autonomy system(s) onboard the robot, etc.). In some implementations, the autonomous robot may travel to an appropriate location/position (e.g., using autonomy system(s) onboard the robot, etc.) at the service destination (e.g., storage facility, distribution facility, etc.).

Optionally, at (1162), the method 1100 can include providing retrieval service completion data to the service entity (e.g., operations computing system). For example, once the autonomous robot has disembarked from the autonomous vehicle, the autonomous vehicle and/or the autonomous robot may provide data indicative of the arrival of the autonomous robot at the retrieval destination to the service entity (e.g., operations computing system 104, etc.). Optionally, at (1164), the method 1100 can include obtaining retrieval service completion data by the service entity, for example, from the autonomous vehicle and/or the autonomous robot. Optionally, at (1166), the method 1100 can include providing retrieval service completion data to the user (e.g., at a remote computing system). Optionally, at (1168), the method 1100 can include obtaining retrieval service completion data by the user. For example, the service entity (e.g., operations computing system 104, etc.) may provide the autonomous robot retrieval service completion data to a user, third party, and/or the like associated with the autonomous robot (e.g., via a user computing device, etc.). The service completion data may include, for example, an identifier associated with the autonomous robot; a location where the autonomous robot disembarked; a time at which the autonomous robot disembarked; and/or the like.

Computing tasks discussed herein as being performed at computing device(s) remote from the autonomous vehicle can instead be performed at the autonomous vehicle (e.g., via the vehicle computing system), or vice versa. Such configurations can be implemented without deviating from the scope of the present disclosure. The use of computer-based systems allows for a great variety of possible configurations, combinations, and divisions of tasks and functionality between and among components. Computer-implemented operations can be performed on a single component or across multiple components. Computer-implements tasks and/or operations can be performed sequentially or in parallel. Data and instructions can be stored in a single memory device or across multiple memory devices.

While the present subject matter has been described in detail with respect to various specific example embodiments thereof, each example is provided by way of explanation, not limitation of the disclosure. Those skilled in the art, upon attaining an understanding of the foregoing, can readily produce alterations to, variations of, and equivalents to such embodiments. Accordingly, the subject disclosure does not preclude inclusion of such modifications, variations and/or additions to the present subject matter as would be readily apparent to one of ordinary skill in the art. For instance, features illustrated or described as part of one embodiment can be used with another embodiment to yield a still further embodiment. Thus, it is intended that the present disclosure cover such alterations, variations, and equivalents.

What is claimed is:

1. A computing system comprising:
one or more processors; and
one or more memories including instructions that, when executed by the one or more processors, cause the one or more processors to perform operations, the operations comprising:
obtaining data associated with a request for an autonomous robot transport service;
determining an availability of one or more autonomous vehicles for the autonomous robot transport service based at least in part on the request for the autonomous robot transport service;
selecting an autonomous vehicle to provide transport of an autonomous robot associated with the autonomous robot transport service based at least in part on the availability of one or more autonomous vehicles and the data associated with the request for the autonomous robot transport service;
generating an autonomous robot service assignment for the selected autonomous vehicle based at least in part on the data associated with the request for the autonomous robot transport service; and
providing data indicative of the autonomous robot service assignment to the selected autonomous vehicle for the selected autonomous vehicle to perform the autonomous robot transport service.

2. The computing system of claim 1, wherein the data associated with the request for the autonomous robot transport service comprises one or more of:
a pickup location;
a drop off location;
a pickup time period;
a drop off time period;
routing preferences;
a number of autonomous robots in a shipment group; or
requested vehicle infrastructure services.

3. The computing system of claim 1, wherein determining the availability of one or more autonomous vehicles for the autonomous robot transport service is further based on one or more of:
vehicle location data;
capacity data;
historical service data; or
demographic data.

4. The computing system of claim 1, wherein the data indicative of the autonomous robot service assignment comprises one or more of:
a pickup location for the autonomous robot;
a destination location for the autonomous robot;
a time period for the autonomous robot transport service;
routing for the autonomous robot transport service; or
identification data associated with autonomous robot.

5. The computing system of claim 1, wherein the operations further comprise:
generating one or more of service timing and service pricing based on the data associated with the request for the autonomous robot transport service.

6. The computing system of claim 1, wherein the operations further comprise:
providing one or more of data associated with the autonomous robot service assignment or data associated with the selected autonomous vehicle to the autonomous robot.

7. The computing system of claim 6, wherein the data associated with the autonomous robot service assignment or data associated with the selected autonomous vehicle comprises data indicative of a pickup location to allow the autonomous robot to travel to the pickup location.

8. The computing system of claim 1, wherein the autonomous robot transport service comprises transporting the autonomous robot for a delivery of one or more items loaded onboard the autonomous robot to a recipient.

9. The computing system of claim 1, wherein the autonomous robot transport service comprises the autonomous robot remaining onboard the autonomous vehicle to allow for dispensing of one or more items loaded onboard the autonomous robot.

10. The computing system of claim 1, wherein the request for the autonomous robot transport service comprises a request to retrieve the autonomous robot from a prior delivery location.

11. The computing system of claim 1, wherein the autonomous vehicle is configured to transport one or more passengers concurrently the autonomous robot.

12. A computer-implemented method, the method comprising:
obtaining, by a computing system comprising one or more comping devices, data associated with a request for an autonomous robot transport service;
determining, by the computing system, an availability of one or more autonomous vehicles for the autonomous robot transport service based at least in part on the request for the autonomous robot transport service;
providing, by the computing system, one or more of service timing or service pricing to a user requesting the autonomous robot transport service based at least in part on the data associated with the request for the autonomous robot transport service and the availability of one or more autonomous vehicles;
selecting, by the computing system, an autonomous vehicle to provide transport of an autonomous robot associated with the autonomous robot transport service based at least in part on the availability of one or more autonomous vehicles and the data associated with the request for the autonomous robot transport service;
generating, by the computing system, an autonomous robot service assignment for the selected autonomous vehicle based at least in part on the data associated with the request for the autonomous robot transport service; and
providing, by the computing system, data indicative of the autonomous robot service assignment to the selected autonomous vehicle.

13. The computer-implemented method of claim 12, wherein the data associated with the request for the autonomous robot transport service comprises one or more of:
a pickup location;
a drop off location;
a pickup time period;
a drop off time period;
routing preferences;
a number of autonomous robots in a shipment group; or
requested vehicle infrastructure services.

14. The computer-implemented method of claim 12, wherein determining the availability of one or more autonomous vehicles for the autonomous robot transport service is further based on one or more of:
vehicle location data;
capacity data;
demand data;
historical service data; or
demographic data.

15. The computer-implemented method of claim 12, wherein the method further comprises:
providing, by the computing system, data indicative of an autonomous vehicle pickup location to the autonomous robot to allow the autonomous robot to travel to the autonomous vehicle pickup location and facilitate boarding the autonomous vehicle.

16. The computer-implemented method of claim 12, wherein the autonomous robot transport service comprises transporting the autonomous robot for a delivery of one or more items loaded onboard the autonomous robot to a recipient.

17. The computer-implemented method of claim 12, wherein the autonomous robot transport service comprises the autonomous robot remaining onboard the autonomous vehicle to allow for dispensing of one or more items loaded onboard the autonomous robot.

18. A system comprising:
an autonomous robot, the autonomous robot comprising:
one or more compartments configured to provide for transporting at least one item;
one or more autonomous vehicles, the one or more autonomous vehicles configured to transport the autonomous robot along with one or more passengers; and
a computing system comprising:
one or more processors; and
one or more memories including instructions that, when executed by the one or more processors, cause the one or more processors to perform operations, the operations comprising:
obtaining data associated with a request for an autonomous robot transport service associated with the autonomous robot;
determining an availability of the one or more autonomous vehicles for the transport service based at least in part on the request for the autonomous robot transport service;
selecting one of the one or more autonomous vehicles to provide transport of the autonomous robot based at least in part on the availability of the one or more autonomous vehicles and the data associated with the request for the autonomous robot transport service;
generating an autonomous robot service assignment for the selected autonomous vehicle based at least in part on the data associated with the request for the autonomous robot transport service; and
providing data indicative of the autonomous robot service assignment to the selected autonomous vehicle.

19. The system of claim 18, wherein the data associated with the request for the autonomous robot transport service comprises one or more of:
a pickup location;
a drop off location;
a pickup time period;
a drop off time period;
routing preferences;
a number of autonomous robots in a shipment group; or requested vehicle infrastructure services.

20. The system of claim 18, wherein the autonomous robot transport service comprises the autonomous robot remaining onboard the selected autonomous vehicle to allow for dispensing of one or more items from one of the one or more compartments.
